(19) United States
(12) Patent Application Publication
(10) Pub. No.: US 2017/0244638 A1
(43) Pub. Date: Aug. 24, 2017

(54) CONTROL APPARATUS, CONTROL METHOD AND CONTROL SYSTEM

(71) Applicant: FUJITSU LIMITED, Kawasaki-shi (JP)

(72) Inventor: Masaki HIROTA, Kawasaki (JP)

(73) Assignee: FUJITSU LIMITED, Kawasaki-shi (JP)

(21) Appl. No.: 15/434,490

(22) Filed: Feb. 16, 2017

(30) Foreign Application Priority Data
Feb. 19, 2016 (JP) 2016-030054

(51) Int. Cl. H04L 12/801; H04L 12/861; H04L 12/835

(52) U.S. Cl. CPC H04L 47/12; H04L 47/30; H04L 49/90

(57) ABSTRACT

A control apparatus including: a memory, and a processor coupled to the memory and the processor configured to: retain first packets in the memory, output the retained first packets to a processing apparatus including a packet processor, receive second packets processed by the packet processor from the processing apparatus, and control outputting of the retained first packets based on the outputted first packets and the received second packets.

### CROSS-REFERENCE TO RELATED APPLICATION

This application is based upon and claims the benefit of priority of the prior Japanese Patent Application No. 2016-030054, filed on Feb. 19, 2016, the entire contents of which are incorporated herein by reference.

### FIELD

The embodiments discussed herein are related to a switching apparatus and a packet processing system.

### BACKGROUND

Recently, there is a packet processing system in which a virtual machine (VM) operates on a computer apparatus such as a server and the virtual machine executes a communication process such as routing for determining a transmission route of a packet.

Where such a packet processing system as described above is used, it is difficult to ensure the throughput performance. Therefore, a switching apparatus is used to distribute packets to a plurality of computer apparatus in each of which a virtual machine operates.

For example, a technology has been proposed which changes the NIC allocated to each virtual machine in response to the load to a computer apparatus using a switching apparatus such as an interconnect switch to reduce the transfer time period of a packet transmitted from the virtual machine (refer to, for example, Japanese Laid-open Patent Publication No. 2014-186411). It is to be noted that NIC is an abbreviation of network interface card.

Also a technology has been proposed which monitors, for each of virtual machines, the resource use rate of a computer apparatus, by which the virtual machines are operated, and adjusts resources to be allocated to the individual virtual machines to optimize the operation state of each of the virtual machines (refer to, for example, Japanese Laid-open Patent Publication No. 2008-293117). It is to be noted that the resources of a computer apparatus include a processing capacity of a processor, a storage capacity of a memory and so forth.

### SUMMARY

According to an aspect of the embodiment, a control apparatus includes a memory, and a processor coupled to the memory and the processor configured to: retain first packets in the memory, output the retained first packets to a processing apparatus including a packet processor, receive second packets processed by the packet processor from the processing apparatus, and control outputting of the retained first packets based on the outputted first packets and the received second packets.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram depicting an embodiment of a switching apparatus and a packet processing system;

FIGS. 2A to 2D are views schematically illustrating an example of operation for packet transfer in the packet processing system depicted in FIG. 1;

FIG. 3 is a block diagram depicting another embodiment of a switching apparatus and a packet processing system;

FIG. 4 is a flow chart illustrating an example of a switching process in the switching apparatus depicted in FIG. 3;

FIG. 5 is a block diagram depicting a further embodiment of a switching apparatus and a packet processing system;

FIG. 6 is a view illustrating an example of a process table illustrated in FIG. 5;

FIG. 7 is a flow chart illustrating an example of a switching process in the switching apparatus depicted in FIG. 5;

FIG. 8 is a block diagram depicting a still further embodiment of a switching apparatus and a packet processing system;

FIG. 9 is a graph illustrating an example of a distribution of a process time period for each chain identification (ID) measured by a first measurement unit depicted in FIG. 8;

FIGS. 10A to 10D are views schematically illustrating an example of operation for packet transfer in the packet processing system depicted in FIG. 8;

FIG. 11 is a flow chart illustrating an example of a switching process in the switching apparatus depicted in FIG. 8;

FIG. 12 is a block diagram depicting a yet further embodiment of a switching apparatus and a packet processing system;

FIG. 13 is a block diagram depicting a different embodiment of a switching apparatus and a packet processing system;

FIG. 14 is a flow chart illustrating an example of a setting process of a process threshold value in the packet processing system depicted in FIG. 13;

FIG. 15 is a block diagram depicting another different embodiment of a switching apparatus and a packet processing system;

FIG. 16 is a flow chart illustrating an example of a switching process in the switching apparatus depicted in FIG. 15;

FIG. 17 is a block diagram depicting a further different embodiment of a switching apparatus and a packet processing system;

FIG. 18 is a view illustrating an example of a process table illustrated in FIG. 17;

FIGS. 19A to 19C are views schematically illustrating an example of operation for packet transfer in the packet processing system depicted in FIG. 17;

FIG. 20 is a flow chart illustrating an example of a setting process of a process time period in the packet processing system depicted in FIG. 17;

FIG. 21 is a flow chart illustrating an example of a switching process in the switching apparatus depicted in FIG. 17;

FIG. 22 is a block diagram depicting a still further different embodiment of a switching apparatus and a packet processing system;

FIGS. 23A and 23B are views schematically illustrating an example of operation for packet transfer in the packet processing system depicted in FIG. 22;

FIGS. 24A and 24B are views illustrating a continuation from the operation example for packet transfer illustrated in FIG. 23;

FIG. 25 is a flow chart illustrating an example of a switching process in the switching apparatus depicted in FIG. 22;

FIG. 26 is a flow chart illustrating a continuation from the switching process illustrated in FIG. 25;

FIG. 27 is a block diagram depicting a yet further different embodiment of a switching apparatus and a packet processing system;

FIG. 28 is a view illustrating an example of a process table illustrated in FIG. 27;

FIG. 29 is a flow chart illustrating an example of a setting process of a process rate in the packet processing system depicted in FIG. 27; and

FIG. 30 is a flow chart illustrating an example of a switching process in the switching apparatus depicted in FIG. 27.

### DESCRIPTION OF EMBODIMENTS

For example, if a computer apparatus such as a server that executes a communication process of a packet receives packets that exceed the processing capacity of the computer apparatus from a network through a switching apparatus, the computer apparatus outputs a stopping request to instruct the switching apparatus or the like to stop transmission of packets. On the other hand, if a virtual machine that executes a communication process and so forth of packets does not have a function for outputting a stopping request of packets, the virtual machine may receive packets exceeding the processing capacity of the virtual machine, resulting in overflow of packets and hence in packet loss.

In one aspect, it is an object in a switching apparatus and a packet processing system according to the present disclosure to control, even where a virtual machine does not have a function for requesting stopping of transmission of packets, the transfer amount of packets by a switching apparatus and suppress packet loss.

In the following, embodiments are described with reference to the drawings.

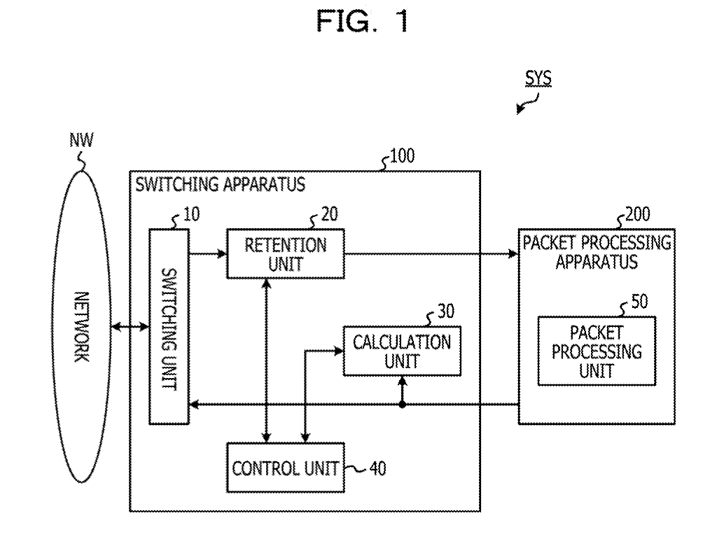

FIG. 1 depicts an embodiment of a switching apparatus and a packet processing system.

A packet processing system SYS depicted in FIG. 1 includes a switching apparatus 100 coupled to a network NW, and a packet processing apparatus 200. The switching apparatus 100 is coupled to the packet processing apparatus 200 through wire or wireless coupling. It is to be noted that the switching apparatus 100 may be coupled to a plurality of packet processing apparatus 200 through wire or wireless coupling.

The packet processing apparatus 200 is a computer apparatus such as a server including an arithmetic processing apparatus such as a processor and a storage apparatus such as a hard disk apparatus. The packet processing apparatus 200 includes one or more packet processing units 50 that execute, for example, a communication process. Where the packet processing apparatus 200 includes a plurality of packet processing units 50, the plurality of packet processing units 50 may execute communication processes different from each other. The packet processing apparatus 200 causes the packet processing unit 50 to execute a communication process corresponding to an internet protocol (IP) packet received from the network NW through the switching apparatus 100. It is to be noted that a function of the packet processing unit 50 is implemented, for example, by a virtual machine executed by the packet processing apparatus 200.

For example, the communication process executed in the packet processing apparatus 200 includes a process of routing for selecting an optimum route from among a plurality of routes in the network NW for the received IP packet (hereinafter referred to also as packet). Further, the communication process executed in the packet processing apparatus 200 includes a process of security architecture for IP (IPsec) for encrypting data included in a packet. Further, the communication process executed in the packet processing apparatus 200 includes a process such as NAPT for converting an IP address and a TCP/UDP port number included in a packet into a different address and a different port number. It is to be noted that TCP is an abbreviation of transmission control protocol. Further, UDP is an abbreviation of user datagram protocol. Further, NAPT is an abbreviation of network address port transmission.

It is to be noted that the communication processes may be executed by one packet processing unit 50.

The packet processing apparatus 200 acquires the substance of a communication process executed for a received packet, for example, based on information of a virtual local area network (VLAN) included in the received packet. The packet processing apparatus 200 causes the packet processing unit 50 to execute a communication process in accordance with the substance of the acquired communication process for the received packet. The packet processing apparatus 200 outputs the packet after processing to the switching apparatus 100.

The switching apparatus 100 includes a switching unit 10, a retention unit 20, a calculation unit 30 and a control unit 40. It is to be noted that, where the switching apparatus 100 is coupled to a plurality of packet processing apparatus 200, the switching apparatus 100 includes a plurality of retention units 20 and a plurality of calculation units 30 individually corresponding to the plurality of packet processing apparatus 200.

The switching unit 10 is a layer 2 switch, a router or the like. The switching unit 10 switches, for example, the output destination of a packet received from the network NW to the packet processing apparatus 200. Then, the switching unit 10 outputs the received packet to the packet processing apparatus 200 of the switched output destination through the retention unit 20. Further, the switching unit 10 receives a packet after processing for which a communication process is executed by the packet processing unit 50 from the packet processing apparatus 200 and transmits the packet after processing to a given transfer destination on the network NW.

The retention unit 20 is a memory having a first-in-first-out function such as a queue. The retention unit 20 retains packets outputted from the switching unit 10 in order therein and outputs the packets in the retention order to the packet processing apparatus 200.

The calculation unit 30 calculates the number of packets whose communication process is being executed by the packet processing apparatus 200 (the number of such packets is hereinafter referred to also as process number) based on the number of packets outputted from the retention unit 20 to the packet processing apparatus 200 and the number of packets after processing received from the packet processing apparatus 200. For example, the calculation unit 30 calculates the difference between the number of packets outputted from the retention unit 20 to the packet processing apparatus 200 and the number of packets after processing received from the packet processing apparatus 200 as the process number of packets being executed by the packet processing apparatus 200. The calculation unit 30 is an example of a first calculation unit.

The control unit 40 is implemented by execution of a program stored in a storage unit such as a memory included in the switching apparatus 100 by a processor or the like included in the switching apparatus 100 and controls operation of the switching apparatus 100. The control unit 40 controls outputting of a packet from the retention unit 20 to the packet processing apparatus 200 based on the process number calculated by the calculation unit 30. For example, the control unit 40 decides whether or not the process number of packets is equal to or greater than a maximum number of packets processable in parallel by the packet processing apparatus 200. In the following description, the maximum number of packets processable by the packet processing apparatus 200 is referred to as credit number. If the process number is lower than the credit number, the control unit 40 issues an instruction to the retention unit 20 to output a packet to the packet processing apparatus 200. On the other hand, if the process number is equal to or greater than the credit number, the control unit 40 issues an instruction to the retention unit 20 to suppress outputting of a packet to the packet processing apparatus 200. In this manner, the control unit 40 controls outputting of a packet from the retention unit 20 to the packet processing apparatus 200 such that the number of packets for which a communication process is being executed by the packet processing apparatus 200 becomes equal to or lower than the credit number.

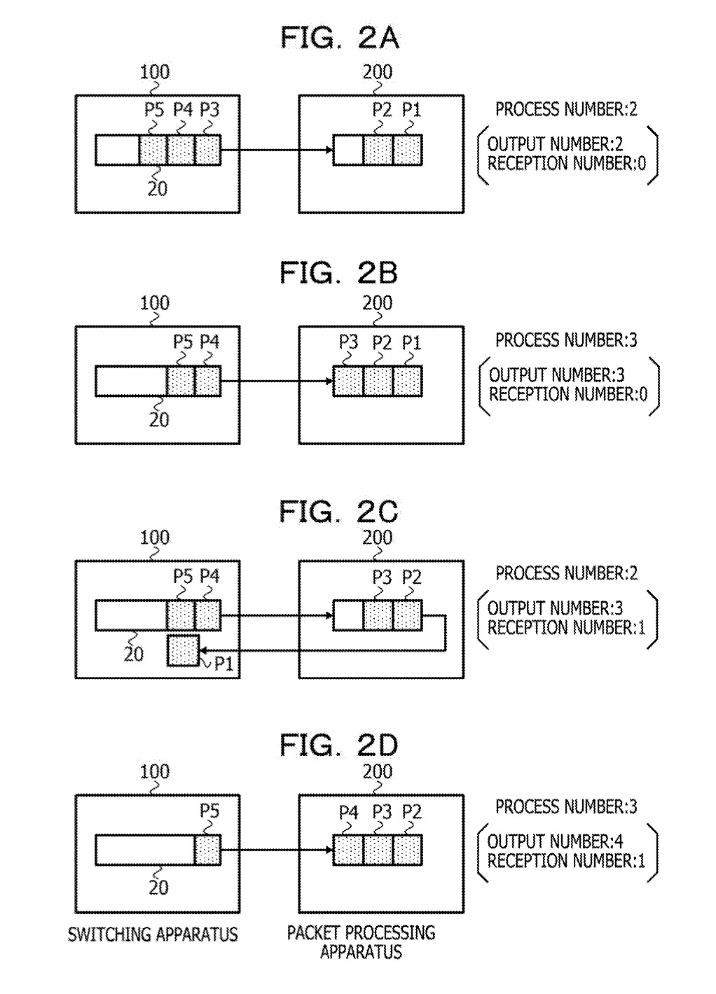

FIG. 2 schematically illustrates an example of operation for packet transfer in the packet processing system SYS depicted in FIG. 1. It is to be noted that it is assumed that, in the example depicted in FIG. 2, the credit number is “3” for the convenience of the description.

FIG. 2A illustrates a state in which the retention unit 20 of the switching apparatus 100 outputs packets P1 and P2 to the packet processing apparatus 200 and the retention unit 20 retains packets P3, P4 and P5 under the control of the control unit 40 depicted in FIG. 1. The packets P1 and P2 are processed by the packet processing unit 50 depicted in FIG. 1. The switching apparatus 100 does not receive any packet processed by the packet processing apparatus 200. Therefore, the calculation unit 30 calculates the difference (“2”) between the number of outputs (hereinafter referred to as output number) (“2”) of the packets P1 and P2 to the packet processing apparatus 200 and the number of receptions (hereinafter referred to as reception number) (“0”) of packets after processing from the packet processing apparatus 200 as the process number of packets being executed by the packet processing apparatus 200. Since the process number (“2”) is smaller by one than the credit number (“3”), the retention unit 20 may output one packet to the packet processing apparatus 200 based on an instruction from the control unit 40.

Therefore, in FIG. 2B, the retention unit 20 outputs the packet P3 to the packet processing apparatus 200 and the packet processing apparatus 200 starts processing of the packet P3. The output number of packets from the retention unit 20 to the packet processing apparatus 200 becomes “3.” The packet processing apparatus 200 is still processing the packets P1 and P2. Therefore, the calculation unit 30 calculates the difference (“3”) between the output number (“3”) of the packets P1 to P3 to the packet processing apparatus 200 and the reception number (“0”) of packets after processing from the packet processing apparatus 200 as the process number in the packet processing apparatus 200. Since the process number is equal to the credit number, the control unit 40 issues an instruction to the retention unit 20 to suppress outputting of a packet to the packet processing apparatus 200.

Then, in FIG. 2C, the packet processing apparatus 200 completes the processing of the packet P1 and outputs the packet P1 after processing to the switching apparatus 100. The switching apparatus 100 receives the packet P1 after processing from the packet processing apparatus 200. The calculation unit 30 calculates the difference (“2”) between the output number (“3”) of the packets P1 to P3 to the packet processing apparatus 200 and the reception number (“1”) of the packet P1 after processing from the packet processing apparatus 200 as the process number in the packet processing apparatus 200. Since the process number (“2”) is smaller by one than the credit number (“3”), the control unit 40 decides that one packet may be outputted from the retention unit 20 to the packet processing apparatus 200.

Then, in FIG. 2D, the retention unit 20 outputs the packet P4 to the packet processing apparatus 200 based on an instruction from the control unit 40 similarly as in the case depicted in FIG. 2B, and the packet processing apparatus 200 starts processing of the packet P4. Therefore, the calculation unit 30 calculates the difference (“3”) between the output number (“4”) of the packet P1 to P4 to the packet processing apparatus 200 and the reception number (“1”) of packets after processing from the packet processing apparatus 200 as the process number in the packet processing apparatus 200. Since the process number is equal to the credit number, the control unit 40 issues an instruction to the retention unit 20 to suppress outputting of a packet to the packet processing apparatus 200.

As described above, in the embodiment depicted in FIGS. 1 and 2, the calculation unit 30 calculates the process number of packets being executed by the packet processing apparatus 200 from the difference between the number of packets outputted to the packet processing apparatus 200 and the number of packets after processing received from the packet processing apparatus 200. Then, the control unit 40 controls outputting of a packet from the retention unit 20 to the packet processing apparatus 200 such that the process number in the packet processing apparatus 200 becomes equal to or smaller than the credit number that is the maximum number of packets processable by the packet processing apparatus 200. For example, the switching apparatus 100 controls outputting of a packet to the packet processing apparatus 200 without receiving information indicating that the packet processing apparatus 200 has no room in the processing capacity of packets from the packet processing apparatus 200. Consequently, also where the packet processing unit 50 of the packet processing apparatus 200 is implemented, for example, by a virtual machine and does not have a function for requesting the switching apparatus 100 to stop transmission of a packet, the packet processing system SYS may control the transfer amount of packets by the switching apparatus 100. As a result, the packet processing system SYS may suppress packet loss.

For example, the virtual machine (for example, the packet processing unit 50) and the number of packets are stored in an associated relationship with each other into the switching apparatus 100, and it is assumed that the number associated with the virtual machine indicates the processing capacity of the virtual machine.

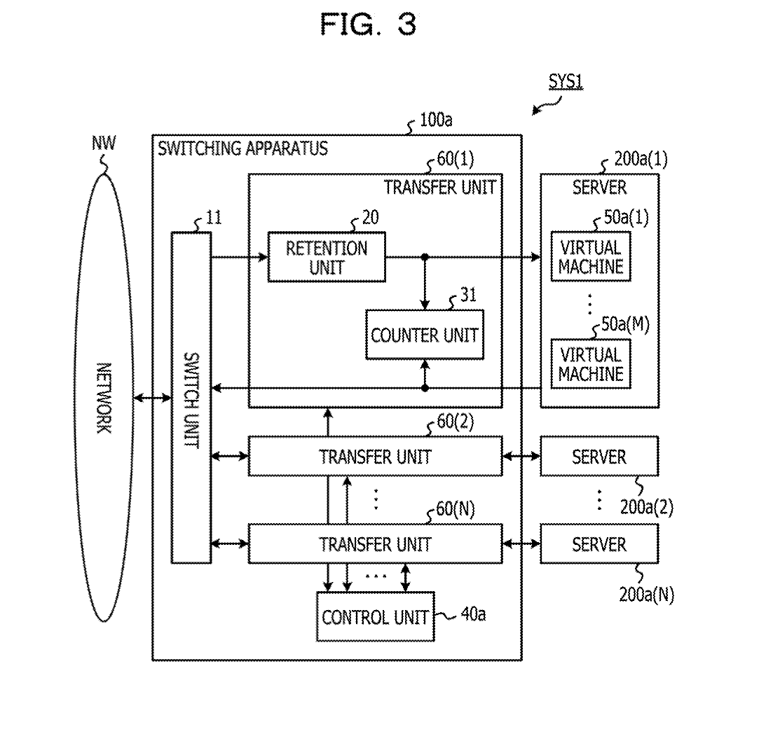

FIG. 3 depicts another embodiment of a switching apparatus and a packet processing system. Elements having functions same as or similar to those of the elements described with reference to FIG. 1 are denoted by the same or like reference symbols, and detailed description of such elements is omitted herein.

A packet processing system SYS1 depicted in FIG. 3 includes a switching apparatus 100a and N servers 200a (200a(1) to 200a(N)). The switching apparatus 100a is coupled to the N servers 200a and a network NW through wire or wireless coupling.

Each of the servers 200a executes, for example, M virtual machines 50a (50a(1) to 50a(M)). The virtual machines 50a individually execute a program to execute programs for communication processes different from each other such as routing and IPsec. The server 200a acquires information indicative of the substance of a communication process to be executed for a received packet based on information of the VLAN or the like included in the received packet. The server 200a transfers the received packet to each of the plurality of virtual machines 50a based on the acquired substance of a communication process and causes the virtual machine 50a to execute the communication process such as routing or IPsec. The server 200a outputs the packet after processing to the switching apparatus 100a. The server 200a is an example of a processing apparatus, and the virtual machine 50a is an example of a packet processing unit.

The switching apparatus 100a includes a switch unit 11, N transfer units 60 (60(1) to 60(N)) and a control unit 40a.

The switch unit 11 is a layer 2 switch, a router or the like, and switches the transmission destination of the packet received from the network NW to one of the N servers 200a. Then, the switch unit 11 outputs the received packet to the server 200a of the switched transmission destination. Further, the switch unit 11 receives a packet after processing for which a communication process is executed from each server 200a through each transfer unit 60, and transmits the received packet to a given transfer destination on the network NW. The switch unit 11 is an example of a switching unit.

The transfer unit 60(1) includes a retention unit 20 and a counter unit 31. It is to be noted that each of the transfer units 60(2) to 60(N) includes the same or similar elements to those of the transfer unit 60(1) depicted in FIG. 3.

The counter unit 31 is an up-down counter or the like, and increases the number of counts (hereinafter referred to as count number) by one every time a packet is outputted from the retention unit 20 to the server 200a(1). Further, the counter unit 31 decreases the count number by one every time a packet after processing for which a communication process is executed is received from the server 200a(1). For example, the count number indicated by the counter unit 31 indicates the number of packets for which a communication process is being executed in the server 200a(1). The counter unit 31 is an example of a calculation unit, and the count number is an example of a process number.

The control unit 40a is implemented, for example, by execution of a program stored in a storage unit such as a memory included in the switching apparatus 100a by a processor or the like included in the switching apparatus 100a, and controls operation of the switching apparatus 100a. Similarly to the control unit 40 depicted in FIGS. 1 and 2, the control unit 40a controls outputting of a packet from the retention unit 20 to the server 200a based on the count number counted by the counter unit 31 in each of the transfer units 60. For example, the control unit 40a controls outputting of a packet from the retention unit 20 to the server 200a in each transfer unit 60 such that the count number becomes equal to or lower than the credit number. It is to be noted that the credit number is the maximum number of packets processable in parallel in the server 200a.

For example, where the count number in the counter unit 31 of the transfer unit 60(1) is smaller than the credit number, the control unit 40a issues an instruction to the retention unit 20 of the transfer unit 60(1) to output a packet to the server 200a(1). On the other hand, where the count number in the counter unit 31 of the transfer unit 60(1) is equal to or greater than the credit number, the control unit 40a issues an instruction to the retention unit 20 of the transfer unit 60(1) to suppress outputting of a packet to the server 200a(1). It is to be noted that, also for the transfer units 60(2) to 60(N), the control unit 40a executes control same as or similar to that for the transfer unit 60(1).

It is to be noted that the packet processing system SYS1 is not limited to the example depicted in FIG. 3. For example, the control unit 40a may be provided in each transfer unit 60 such that it controls operation of the transfer unit 60. Further, the credit number may have a value that differs among the different transfer units 60.

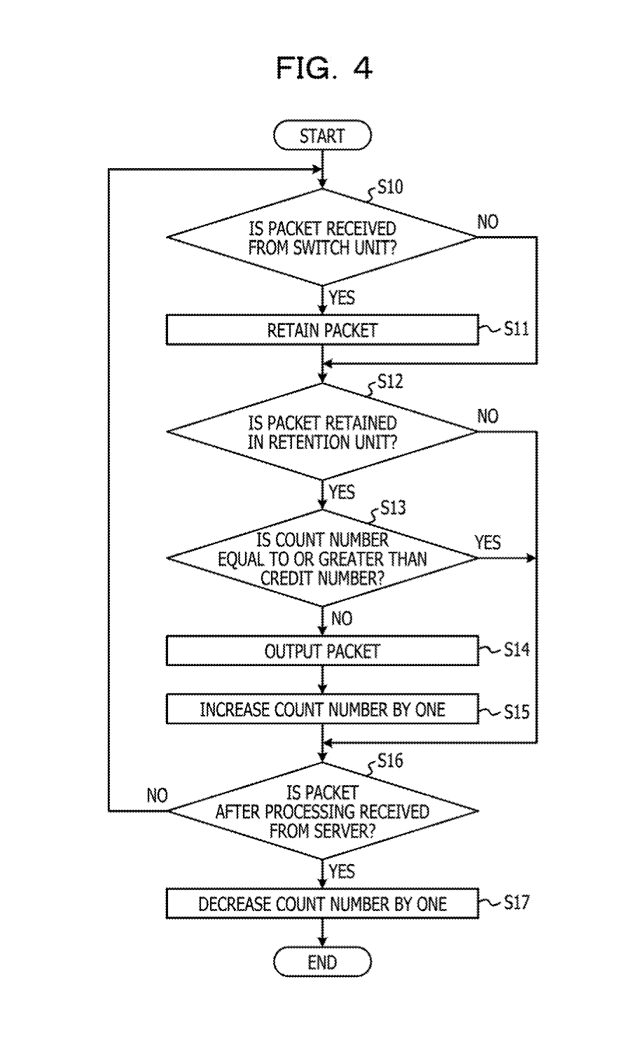

FIG. 4 illustrates an example of a switching process in the switching apparatus 100a depicted in FIG. 3. The process depicted in FIG. 4 is implemented by operation of the switch unit 11, N transfer units 60 and control unit 40a incorporated in the switching apparatus 100a.

It is to be noted that the process illustrated in FIG. 4 indicates a case in which a packet is transferred between the transfer unit 60(1) of the switching apparatus 100a and the server 200a(1). Also where a packet is transferred between each of the transfer units 60(2) to 60(N) and a corresponding one of the servers 200a(2) to 200a(N), a process same as or similar to the process illustrated in FIG. 4 is executed.

At step S10, the control unit 40a decides whether or not the transfer unit 60(1) receives a packet from the switch unit 11. If a packet is received, the processing of the switching apparatus 100a advances to step S11. On the other hand, if a packet is not received, the processing of the switching apparatus 100a advances to step S12.

At step S11, the retention unit 20 successively retains the packets received at step S10. After the process at step S11 is executed, the processing of the switching apparatus 100a advances to step S12.

At step S12, the control unit 40a decides whether or not a packet is retained in the retention unit 20 of the transfer unit 60(1). If a packet is retained in the retention unit 20 of the transfer unit 60(1), the processing of the switching apparatus 100a advances to step S13. On the other hand, if a packet is not retained in the retention unit 20 of the transfer unit 60(1), the processing of the switching apparatus 100a advances to step S16.

At step S13, the control unit 40a decides whether or not the count number of the counter unit 31 of the transfer unit 60(1) is equal to or greater than the credit number. If the count number is smaller than the credit number, the processing of the switching apparatus 100a advances to step S14. On the other hand, if the count number is equal to or greater than the credit number, the processing of the switching apparatus 100a advances to step S16.

At step S14, the control unit 40a outputs an instruction to the retention unit 20 of the transfer unit 60(1) to output a packet retained at the top of the retention unit 20 to the server 200a(1). Then, the processing of the switching apparatus 100a advances to step S15. Here, the packet retained at the top of the retention unit 20 is a packet received oldest from among packets retained in the retention unit 20.

At step S15, the counter unit 31 of the transfer unit 60(1) increases the count number by one based on outputting of a packet from the retention unit 20 to the server 200a(1). After the process at step S15 is executed, the processing of the switching apparatus 100a advances to step S16.

At step S16, the counter unit 31 of the transfer unit 60(1) decides whether or not a packet after processing is received from the server 200a(1). If a packet after processing is received, the processing of the switching apparatus 100a advances to step S17. On the other hand, if a packet after processing is not received, the processing of the switching apparatus 100a returns to step S10.

At step S17, the counter unit 31 of the transfer unit 60(1) decreases the count number by one. After the process at step S17 is executed, the switching apparatus 100a ends the processing.

Then, the switching apparatus 100a repetitively executes the processes from step S10 to step S17. It is to be noted that the processes from step S10 to step S15 and the processes at steps S16 and S17 may be executed in parallel to each other.

As described above, in the embodiment depicted in FIGS. 3 and 4, the counter unit 31 calculates the process number of packets being executed by the server 200a from the difference between the number of packets outputted to the server 200a and the number of packets after processing received from the server 200a. Then, the control unit 40a controls outputting of a packet from the retention unit 20 to the server 200a such that the process number in the server 200a becomes equal to or smaller than the credit number that is the maximum number of packets processable by the server 200a. For example, the switching apparatus 100a controls outputting of a packet to the server 200a without receiving information indicating that the server 200a has no room in the processing capacity of packets from the server 200a. Consequently, also where the plurality of virtual machines 50a being executed in each server 200a do not have, for example, a function for requesting the switching apparatus 100a to stop transmission of a packet, the packet processing system SYS1 may control the transfer amount of packets by the switching apparatus 100a. As a result, the packet processing system SYS1 may suppress packet loss.

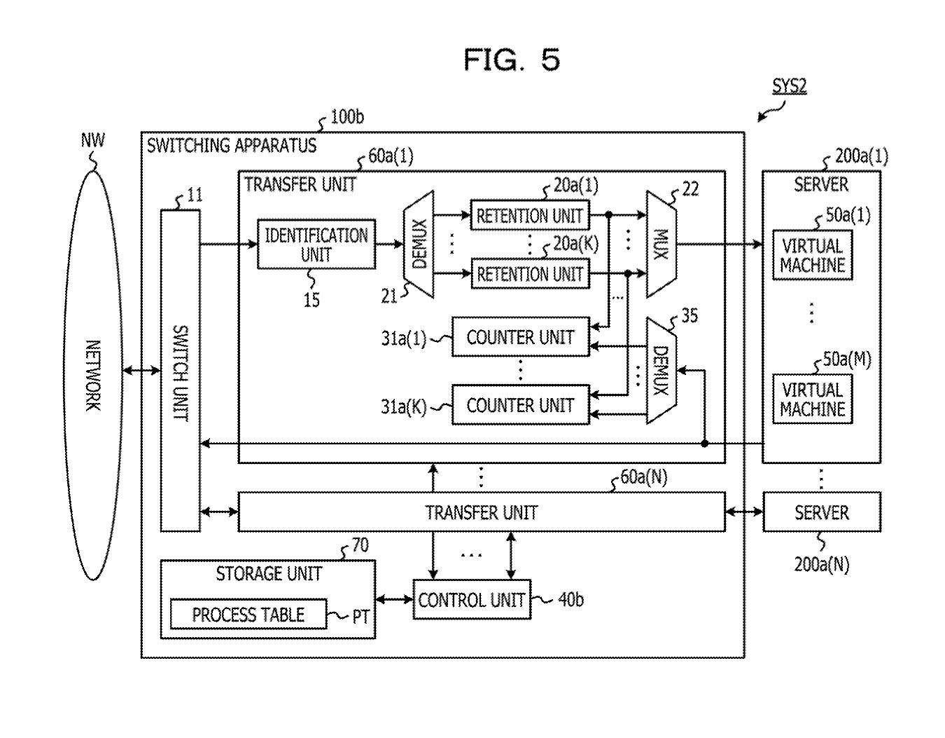

FIG. 5 depicts a further embodiment of a switching apparatus and a packet processing system. Elements having functions same as or similar to those of the elements described with reference to FIG. 3 are denoted by the same or like reference symbols, and detailed description of such elements is omitted herein.

A packet processing system SYS2 depicted in FIG. 5 includes a switching apparatus 100b and N servers 200a. The switching apparatus 100b is coupled to the N servers 200a and a network NW through wire or wireless coupling.

The switching apparatus 100b includes a switch unit 11, N transfer units 60a (60a(1) to 60a(N)), a control unit 40b and a storage unit 70.

The transfer unit 60a(1) includes an identification unit 15, a demultiplexer (DEMUX) 21, K retention units 20a (20a(1) to 20a(K)) and a multiplexer (MUX) 22. Further, the transfer unit 60a(1) includes a DEMUX 35 and K counter units 31a (31a(1) to 31a(K)). It is to be noted that each of the transfer units 60a(2) to 60a(N) includes elements same as or similar to those of the transfer unit 60a(1) depicted in FIG. 5.

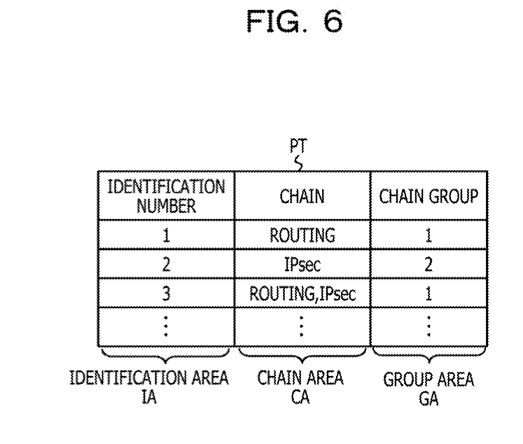

The identification unit 15 acquires, for example, information of a VLAN identifier (VID) included in the VLAN tag header added to a packet based on a communication standard such as IEEE802.1p. It is to be noted that IEEE is an abbreviation of The Institute of Electrical and Electronics Engineers, Inc. The identification unit 15 identifies the substance of a communication process executed in the server 200a(1) based on the acquired information of a VID or the like and a process table PT stored in the storage unit 70. Further, the identification unit 15 adds identification information indicative of the identified substance of the communication process to a packet and outputs the packet to which the identification information is added to the DEMUX 21. The substance of operation of the identification unit 15, the process table PT and the communication process is described with reference to FIG. 6. The substance of the communication process is an example of process information.

The DEMUX 21 outputs a received packet to one of the retention units 20a based on the identification information added to the packet. For example, the DEMUX 21 outputs the packet to the retention unit 20a for each kind of identification information. For example, the DEMUX 21 outputs a packet for which a same or similar communication process is executed in the server 200a(1) to the same retention unit 20a. For example, the retention unit 20a is provided for each kind of communication process executed in the server 200a(1).

Each of the retention units 20a is a memory having a first-in-first-out function such as a queue. Each retention unit 20a successively retains packets received from the DEMUX 21. Each retention unit 20a outputs the packets in the retention order to the server 200a(1).

The MUX 22 outputs packets outputted from each retention unit 20a to the server 200a(1).

The DEMUX 35 receives a packet after processing from the server 200a(1). The DEMUX 35 outputs information indicative of reception of a packet to one of the counter units 31a based on identification information included in the received packet. It is to be noted that the identification information is added to a packet by the identification unit 15.

The counter unit 31a is provided corresponding to each of the retention units 20a. Each of the counter units 31a is an up-down counter or the like similarly to the counter unit 31 depicted in FIG. 3, and increases the count number by one every time a packet received from the DEMUX 21 is outputted from each retention unit 20a to the server 200a(1). Further, each counter unit 31a decreases the count number by one every time information indicative of reception of a packet is received from the DEMUX 35. Consequently, the count number indicated by each counter unit 31a indicates the number of packets for which a communication process having the same or similar contents is being executed in the server 200a(1).

The control unit 40b is implemented, for example, by execution of a program stored in the storage unit 70 by a processor or the like included in the switching apparatus 100b, and controls operation of the switching apparatus 100b. The control unit 40b controls outputting of a packet from each retention unit 20a to the server 200a based on the count number counted by the corresponding counter unit 31a in each transfer unit 60a. For example, if the count number in the counter unit 31a(1) of the transfer unit 60a(1) is smaller than the credit number, the control unit 40b issues an instruction to the retention unit 20a(1) of the transfer unit 60a(1) to output a packet to the server 200a(1). On the other hand, if the count number in the counter unit 31a(1) of the transfer unit 60a(1) is equal to or greater than the credit number, the control unit 40b issues an instruction to the retention unit 20a(1) of the transfer unit 60a(1) to suppress outputting of a packet to the server 200a(1). For example, outputting control on each retention unit 20a by the control unit 40b is similar to that in the example of operation by the control unit 40 depicted in FIG. 2.

It is to be noted that, also for the retention units 20a(2) to 20a(K) of the transfer unit 60a(1), the control unit 40b executes control same as or similar to that for the retention unit 20a(1) based on comparison between the count number of each of the counter unit 31a(2) to 31a(K) and the credit number. Further, also for the transfer units 60a(2) to 60a(N), the control unit 40b executes control same as or similar to that for the transfer unit 60a(1).

The storage unit 70 is a memory such as a random access memory (RAM) and includes a storage area in which a program executed by the control unit 40b, a process table PT and so forth are stored. An example of the process table PT is depicted in FIG. 6.

It is to be noted that the packet processing system SYS2 is not limited to the example depicted in FIG. 5. For example, the control unit 40b may be provided in each transfer unit 60a. Further, the credit number may differ among the different transfer units 60a and may differ among the different retention units 20a (or counter units 31a).

FIG. 6 illustrates an example of the process table PT depicted in FIG. 5. The process table PT has a plurality of entries each including an identification area IA for retaining an identification number, a chain area CA for retaining a chain and a group area GA for retaining a chain group. A value of the VID for identifying the VLAN to which a packet belongs is stored as an identification number in the identification area IA. The value of the VID is included in the VLAN tag header added to a packet received from the network NW. It is to be noted that, in the identification area IA, an IP address, a media access control (MAC) address or the like indicative of a transmission destination or a transmission source of a received packet may be stored in place of the VID.

In the chain area CA, information indicative of the substance of a communication process executed for each packet having a VID (identification number) stored in the identification area IA (such information is hereafter referred to also as chain) is stored. For example, where a chain executed for a packet whose identification number is “1” indicates a communication process of routing, information indicating routing is stored in the chain area CA corresponding to the identification number (VID) of “1.” Where a chain executed for a packet whose identification number is “2” indicates a communication process of IPsec, information indicating IPsec is stored in the chain area CA of the identification number (VID) of “2.” Further, where a chain executed for a packet whose identification number is “3” indicates communication processes of routing and IPsec, information indicating routing and IPsec is stored in the chain area CA corresponding to the identification number (VID) of “3.”

In the group area GA, information indicative of a group in which chains are grouped based on a common communication process from among the communication processes indicated by the chains stored in the chain area CA is stored. For example, in the process table PT depicted in FIG. 6, the chain whose identification number (VID) is “1” and the chain whose identification number (VID) is “3” include the communication process of routing in common. Therefore, “1” indicating the same group (hereinafter referred to also as chain group) is stored in the group area GA whose identification number is “1” or “3.” On the other hand, the chain whose identification number is “2” does not include the communication process of routing of the chains whose identification number is “1” and “3.” Therefore, “2” indicating a chain group different from the chain group whose identification number of the identification area IA is “1” or “3” is stored in the group area GA whose identification number is “2.” It is to be noted that, while a numerical value is stored in the group area GA in order to indicate each chain group, a character, a combination of a character and a numerical value or the like may be stored.

It is to be noted that, in the process table PT depicted in FIG. 6, the chain whose identification number is “2” and the chain whose identification number is “3” include the communication process of IPsec in common. Therefore, taking notice of the communication process of IPsec, in the group area GA whose identification number is “3”, “2” may be stored in place of “1.”

It is to be noted that, before the switching apparatus 100b executes transmission and reception operation of a packet, the process table PT is stored in advance in the storage unit 70 by the packet processing system SYS2 or a monitoring apparatus such as a computer apparatus coupled to the network NW.

The identification unit 15 depicted in FIG. 5 acquires, for example, the VID included in the VLAN tag header added to a received packet. The identification unit 15 refers to the process table PT through the control unit 40b and acquires a chain group corresponding to the substance (chain) of a communication process corresponding to the acquired VID. Further, the identification unit 15 adds the acquired chain group as identification information indicating a chain of a packet to the received packet. It is to be noted that the identification unit 15 may add an identification number of the identification area IA corresponding to the chain as the identification information indicating a chain of a packet to the received packet.

The DEMUX 21 depicted in FIG. 5 outputs a packet received from the identification unit 15 to one of the retention units 20a based on the identification information added to the packet received from the identification unit 15. For example, if the identification information included in the received packet indicates the chain group “1,” the DEMUX 21 outputs the received packet to the retention unit 20a(1). If the identification information included in the received packet indicates the chain group “2,” the DEMUX 21 outputs the received packet to the retention unit 20a(2). Consequently, each of the retention units 20a retains packets of the same chain group in order.

On the other hand, the DEMUX 35 outputs, every time a packet after processing is received from the server 200a(1), information indicative of reception of a packet to one of the counter units 31a based on the identification information included in the packet. For example, if the identification information included in the received packet after processing indicates the chain group “1,” the DEMUX 35 outputs information indicative of reception of a packet to the counter unit 31a(1). Further, if the identification information included in the received packet after processing indicates the chain group “2,” the DEMUX 35 outputs information indicative of reception of a packet to the counter unit 31a(2). Each of the counter units 31a decreases the count number by one every time the information indicative of reception of a packet is received from the DEMUX 35. For example, each of the counter units 31a counts the number of packets for which a communication process is executed in the server 200a(1) for each of chain groups. It is to be noted that the processing load where the server 200a(1) executes a communication process of a packet differs in accordance with the chain group (the substance of the communication process). Therefore, each counter unit 31a counts the process number for each chain group, and the control unit 40b controls outputting of a packet to the server 200a(1) for each retention unit 20a based on the process number of each counter unit 31a and the credit number of each chain group. For example, as the control unit 40b controls outputting of a packet to the server 200a(1) for each chain group, the packet processing system SYS2 may effectively process packets in comparison with a case in which one counter unit 31 depicted in FIG. 3 counts the number of packets.

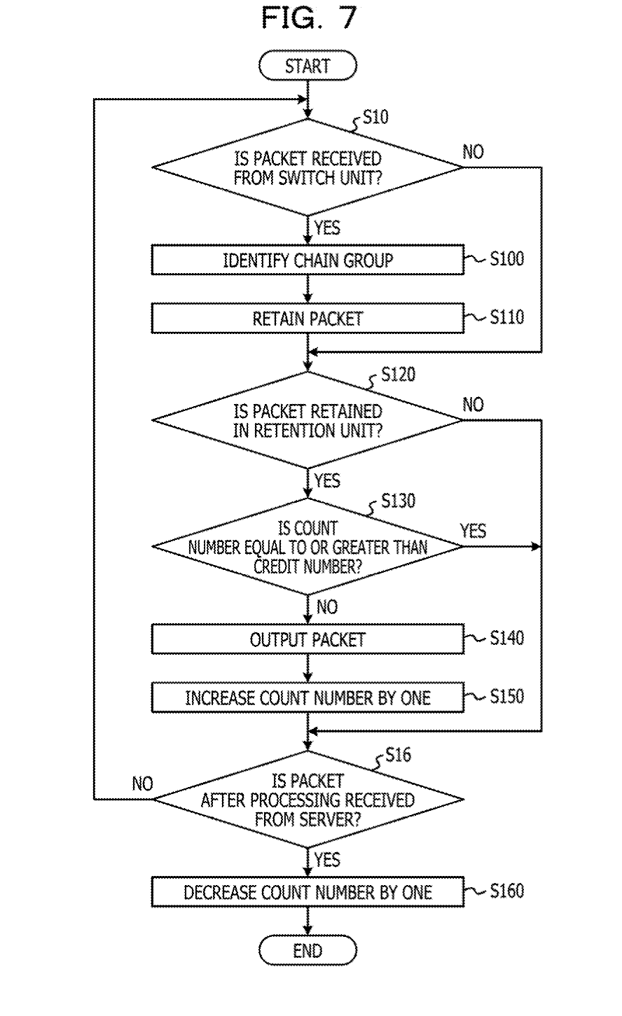

FIG. 7 depicts an example of a switching process in the switching apparatus 100b depicted in FIG. 5. It is to be noted that, from among processes at steps depicted in FIG. 7, processes same as or similar to those at the steps described with reference to FIG. 4 are denoted by the same step numbers and detailed description of them is omitted herein. The process illustrated in FIG. 7 is implemented by operation of the switch unit 11, N transfer units 60a and control unit 40b incorporated in the switching apparatus 100b.

It is to be noted that the process illustrated in FIG. 7 indicates a case in which a packet is transferred between the transfer unit 60a(1) and the server 200a(1). Also in a case in which a packet is transferred between each of the transfer units 60a(2) to 60a(N) and a corresponding one of the servers 200a(2) to 200a(N), a same or similar process to that illustrated in FIG. 7 is executed.

If it is decided at step S10 that a packet is received, the switching apparatus 100b advances the processing to step S100, and if it is decided that a packet is not received, the processing advances to step S120.

At step S100, the identification unit 15 identifies the chain group of the packet received at step S10 based on the VID of the VLAN tag header added to the packet and the process table PT depicted in FIG. 6. After the process at step S100 is executed, the processing of the switching apparatus 100b advances to step S110.

At step S110, each of the retention units 20a receives packets sorted by the DEMUX 21 depending on the chain group identified at step S100 and retains the received packets in order. After the process at step S110 is executed, the processing of the switching apparatus 100b advances to step S120.

At step S120, the control unit 40b decides whether or not a packet is retained in each of the retention units 20a (for example, for each chain group). Then, the processing of the switching apparatus 100b for the retention unit 20a that retains a packet advances to step S130. On the other hand, the processing of the switching apparatus 100b for the retention unit 20a that does not retain a packet advances to step S16.

At step S130, the control unit 40b decides whether or not the count number of the counter unit 31a of the chain group corresponding to the retention unit 20a with regard to which it is decided at step S120 that a packet is retained is equal to or greater than the credit number. If the count number is smaller than the credit number, the processing of the switching apparatus 100b advances to step S140. On the other hand, if the count number is equal to or greater than the credit number, the processing of the switching apparatus 100b advances to step S16.

At step S140, the control unit 40b issues an instruction to the retention unit 20a of a chain group, with regard to which it is decided at step S130 that the count number of the counter unit 31a is smaller than the credit number, to output a packet to the server 200a(1). After the process at step S140 is executed, the processing of the switching apparatus 100b advances to step S150.

At step S150, the counter unit 31a corresponding to the chain group of the packet outputted at step S140 increases the count number by one. After the process at step S150 is executed, the switching apparatus 100b executes processes at steps S16 and S160. It is to be noted that, if the counter unit 31a receives a packet after processing from the server 200a(1) at step S16 depicted in FIG. 7, the processing of the switching apparatus 100b advances to step S160.

At step S160, the counter unit 31a corresponding to the chain group added to the packet after processing received at step S16 decreases the count number by one. After the process at step S160 is executed, the switching apparatus 100b ends the packet process.

Then, the switching apparatus 100b repetitively executes the processes at steps S10, S100 to S150, S16 and S160. It is to be noted that the processes at steps S10 and S100 to S150 and the processes at steps S16 and S160 may be executed in parallel.

As described above, in the embodiment depicted in FIGS. 5 to 7, each counter unit 31a calculates the process number of packets for which a communication process is being executed in the server 200a for each chain group (substance of the communication process). Then, the control unit 40b controls outputting of a packet from each retention unit 20a to the server 200a such that the process number for each chain group becomes equal to or smaller than the credit number that is the maximum number of packets processable in the server 200a. For example, the switching apparatus 100b controls outputting of a packet to the server 200a without receiving information indicating that the server 200a has no room in the processing capacity of packets from the server 200a. Consequently, even where the plurality of virtual machines 50a being executed in each server 200a do not have a function for requesting the switching apparatus 100b to stop transmission of a packet, the packet processing system SYS2 may control the transfer amount of packets by the switching apparatus 100b. As a result, the packet processing system SYS2 may suppress packet loss.

Further, the process load to the server 200a differs among different chain groups. Therefore, the control unit 40b controls outputting of a packet to the server 200a from each retention unit 20a based on the process number of each counter unit 31a and the credit number for each chain group. Consequently, the switching apparatus 100b may transfer packets more efficiently than where the single counter unit 31 depicted in FIG. 3 counts the number of packets, and the processing efficiency of packets in the packet processing system SYS2 may be improved.

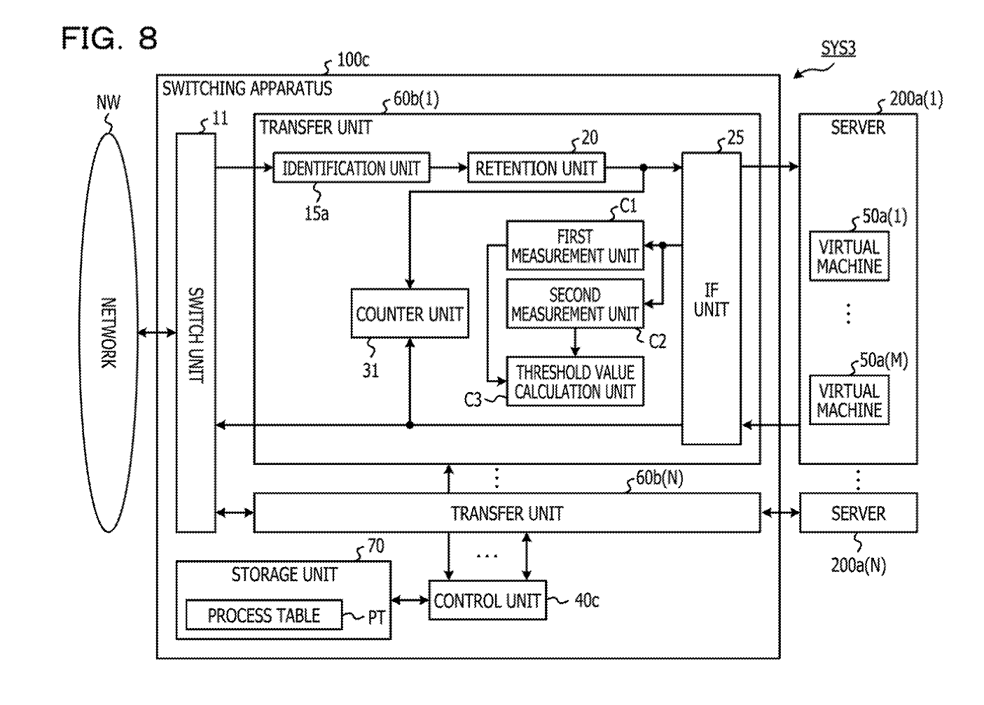

FIG. 8 depicts a still further embodiment of a switching apparatus and a packet processing system. Elements having functions same as or similar to those of the elements described with reference to FIG. 3 or 5 are denoted by the same or like reference symbols, and detailed description of such elements is omitted herein.

A packet processing system SYS3 depicted in FIG. 8 includes a switching apparatus 100c and N servers 200a. The switching apparatus 100c is coupled to the N servers 200a and a network NW by wire or wireless coupling.

The switching apparatus 100c includes a switch unit 11, N transfer units 60b (60b(1) to 60b(N)), a control unit 40c and a storage unit 70.

The transfer unit 60b(1) includes an identification unit 15a, a retention unit 20, an interface (IF) unit 25, a counter unit 31, a first measurement unit C1, a second measurement unit C2 and a threshold value calculation unit C3. It is to be noted that each of the transfer units 60b(2) to 60b(N) includes the same or similar elements to those of the transfer unit 60b(1) depicted in FIG. 8.

The identification unit 15a acquires a VID (identification number) added to a received packet similarly to the identification unit 15 depicted in FIG. 5. Then, the identification unit 15a refers to the process table PT depicted in FIG. 6 and adds, to the received packet, an identification number (hereinafter referred to also as chain ID) in the identification area IA same as the acquired VID as information indicative of the chain (substance of the communication process) of the received packet.

Further, the identification unit 15a adds information such as a serial number for identifying each packet to the packet. Then, the identification unit 15a outputs the packet to which the chain ID and the serial number are added to the retention unit 20.

The IF unit 25 is an input/output (I/O) interface or the like, and outputs a packet received from the retention unit 20 to the server 200a(1) and outputs a packet after processing received from the server 200a(1) to the switch unit 11. Further, for example, when a packet received from the retention unit 20 is outputted to the server 200a(1), the IF unit 25 outputs the chain ID and the serial number added to the packet to the first measurement unit C1 and the second measurement unit C2. Further, the IF unit 25 refers to information indicative of time outputted from a clock circuit included in the switching apparatus 100c or the like and acquires time information such as a timestamp indicative of transmission time at which the packet received from the retention unit 20 is outputted to the server 200a(1). The IF unit 25 outputs the acquired time information to the first measurement unit C1 and the second measurement unit C2.

Further, the IF unit 25 refers, for example, to the information indicative of the time outputted from the clock circuit of the switching apparatus 100c or the like and acquires time information such as a timestamp indicative of reception time when the IF unit 25 receives a packet after processing from the server 200a(1). The IF unit 25 outputs the time information at which the packet after processing is received and the chain ID and the serial number added to the packet after processing to the first measurement unit C1.

The first measurement unit C1 measures, for each chain ID (for example, for the substance of each communication process), a process time period spent on a communication process of a packet in the server 200a(1). For example, the first measurement unit C1 measures the process time period from the difference between the timestamp of the reception time and the timestamp of the transmission time of packets to which the same serial number is added. The first measurement unit C1 outputs the measured process time period in an associated relationship with the chain ID of the packet to the threshold value calculation unit C3.

The second measurement unit C2 measures, when the count number of the counter unit 31 is equal to the credit number, the period of time elapsed after the time at which the retention unit 20 outputted a packet last. For example, the second measurement unit C2 acquires from the IF unit 25 the chain ID, the serial number and the timestamp of the transmission time of the packet outputted last from the retention unit 20. Then, the second measurement unit C2 measures, based on the information indicative of the time outputted from the clock circuit of the switching apparatus 100c and the timestamp of the transmission time acquired from the IF unit 25, the elapsed time period from the time at which the retention unit 20 outputted a packet last. The second measurement unit C2 outputs the measured elapsed time period in an associated relationship with the chain ID of the packet to the threshold value calculation unit C3.

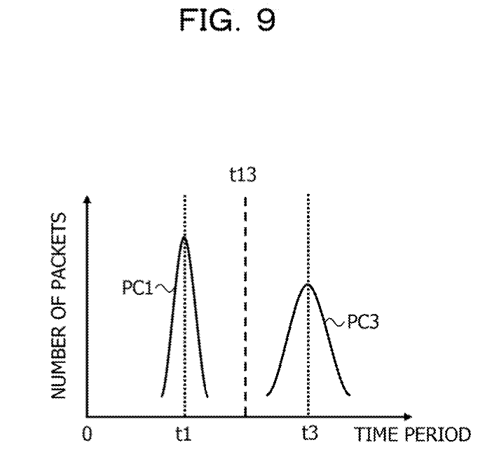

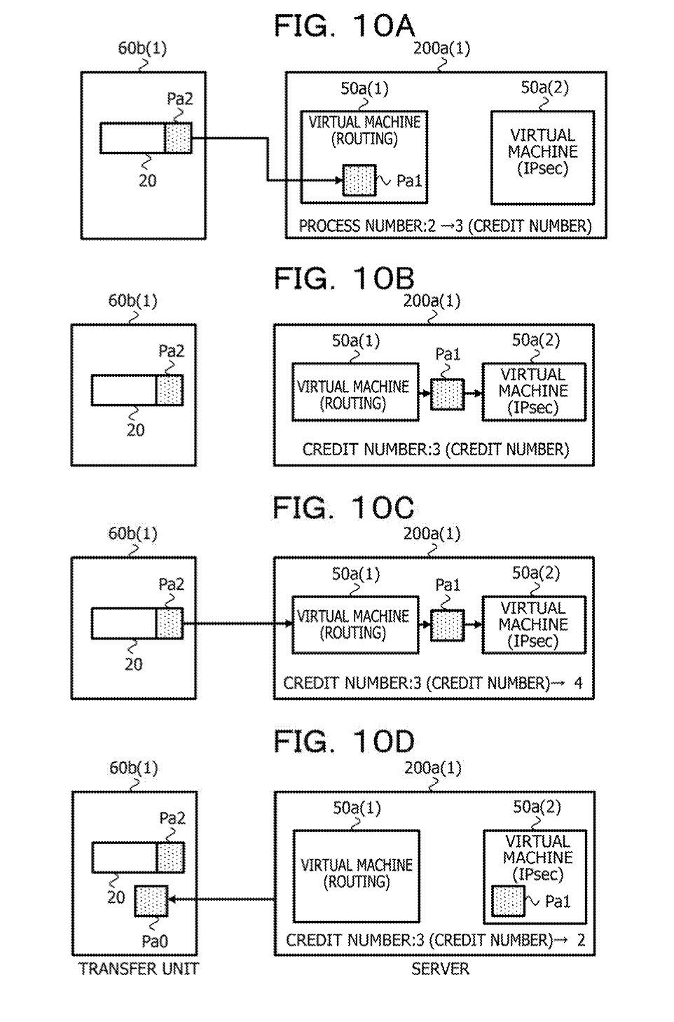

The threshold value calculation unit C3 calculates, using the process time period for each chain ID (substance of the communication process) measured by the first measurement unit C1, a threshold value for a period of time in which it is estimated from the elapsed time period measured by the second measurement unit C2 that, between each adjacent chain IDs, processing of one of the chain IDs ends in the server 200a. Operation of the threshold value calculation unit C3 is described with reference to FIGS. 9 and 10. The threshold value calculation unit C3 is an example of a second calculation unit.

The control unit 40c is implemented, for example, by a processor or the like included in the switching apparatus 100c executing a control program stored in the storage unit 70 and controls operation of the switching apparatus 100c. Then, similarly to the control unit 40a depicted in FIG. 3, the control unit 40c controls outputting of a packet to the server 200a by the retention unit 20 of each transfer unit 60b based on the count number counted by the counter unit 31.

However, even if the count number of the counter unit 31 is equal to or greater than the credit number, if a given condition (hereinafter referred to also as credit excess condition) is satisfied, the control unit 40c causes the retention unit 20 of the transfer unit 60b(1) to output a packet to the server 200a(1). The credit excess condition and operation of the control unit 40c are described with reference to FIGS. 9 and 10.

It is to be noted that, also for the transfer units 60b(2) to 60b(N), the control unit 40c executes control same as or similar to that for the transfer unit 60b(1).

It is to be noted that the credit number may have values different from each other among the transfer units 60b.

FIG. 9 illustrates an example of a distribution of a process time period for each chain ID measured by the first measurement unit C1 depicted in FIG. 8. In FIG. 9, the axis of ordinate indicates the number of packets measured by the first measurement unit C1 and the axis of abscissa indicates the process time period of packets in the server 200a. A distribution PC1 illustrated in FIG. 9 is a distribution of the process time period, for example, of a packet whose chain ID is “1” (for example, the communication process executed in the server 200a is routing). Another distribution PC3 is a distribution of the process time period, for example, of a packet whose chain ID is “3” (for example, the communication process executed in the server 200a is routing and IPsec). A process time period t1 is a period of time after which a peak of the distribution PC1 appears, and another process time period t3 is a period of time after which a peak of the distribution PC3 appears. It is to be noted that the process time periods t1 and t3 may be average time periods of the distributions PC1 and PC3, respectively.

As illustrated in FIG. 9, the distribution PC3 of the process time period of a packet whose chain ID is “3” is positioned on the right side with respect to the distribution PC1 of the process time period of a packet whose chain ID is “1” because the communication process including the two processes for routing and IPsec are executed for a packet. For example, it is indicated that, in the server 200a(1), the communication process for a packet whose chain ID is “3” is heavier in load than the communication process for a packet whose chain ID is “1.”

Further, since the process time period of the communication process that includes only routing of a packet whose chain ID is “1” is included in the distribution PC1, the communication process including only routing is completed before a point of time t13 spaced to the side at which the process time period is longer from the distribution PC1. Therefore, when a packet whose chain ID is “3” is processed successively for routing and IPsec, it is estimated that the communication process of routing from within the communication process for a packet whose chain ID is “3” ends before the time t13. It is to be noted that the time t13 is, for example, a point of time at an average value or the like of the process time periods t1 and t3.

FIG. 10 schematically illustrates an example of operation for packet transfer in the packet processing system SYS3 depicted in FIG. 8. It is to be noted that, in the example illustrated in FIG. 10, it is assumed that the maximum number of packets processable by the server 200a(1) (credit number) is “3” and the number of packets being processed in the server 200a(1) (process number) is “2” similarly as in the case of FIG. 2. Further, it is assumed that, in the example illustrated in FIG. 10, the chain ID of a packet Pa1 is “3.”

In FIG. 10A, since the process number “2” is smaller by one than the credit number “3,” the retention unit 20 of the transfer unit 60b(1) outputs the packet Pa1 to the server 200a(1) and retains a packet Pa2 under the control of the control unit 40c depicted in FIG. 8. In this case, the counter unit 31 of the transfer unit 60b(1) increases the process number by one to count “3.” Then, since the process number is equal to the credit number, the control unit 40c outputs an instruction to the retention unit 20 to suppress outputting of the packet Pa2 to the server 200a(1).

Meanwhile, since the packet Pa1 is a packet outputted last from the retention unit 20, the second measurement unit C2 of the transfer unit 60b(1) starts measurement of the elapsed time period. Further, since the chain ID of the packet Pa1 is “3,” the server 200a(1) transfers the packet Pa1 to the virtual machine 50a(1) that executes a communication process of routing, and the virtual machine 50a(1) starts a communication process of routing for the packet Pa1.

Then, in FIG. 10B, before the elapsed time period of the second measurement unit C2 becomes equal to a time period at time t13 illustrated in FIG. 9, the server 200a(1) transfers the packet Pa1, for which the routing process in the virtual machine 50a(1) has ended, to the virtual machine 50a(2) that executes a process of IPsec. In this case, since the process number (“3”) is equal to the credit number (“3”), the control unit 40c outputs an instruction to the retention unit 20 to suppress outputting of the packet Pa2 to the server 200a(1).

However, since the packet Pa1 whose chain ID is “3” is transferred to the virtual machine 50a(2) before the elapsed time period of the second measurement unit C2 becomes equal to a time period at time t13, the virtual machine 50a(1) waits until it receives the packet Pa2. For example, the server 200a may execute at least a communication process of routing or a communication process of a process load equivalent to that of the communication process of routing within the range of the processing capacity of the server 200a.

Therefore, as illustrated in FIG. 10C, where the elapsed time period is equal to or longer than the time period at time t13 and the chain ID of the next packet Pa2 is “1,” the retention unit 20 outputs the packet Pa2 to the server 200a(1) independently of the process number in accordance with an instruction of the control unit 40c. For example, when the elapsed time period is equal to or longer than the time period at time t13, the control unit 40c decides that the server 200a(1) has ended the communication process of routing for the packet Pa1 outputted last from the retention unit 20. Then, when the chain ID of the next packet Pa2 is “1” or the like (for example, when the process load of the chain ID (“1” or the like) of the next packet Pa2 is lighter than the process load of the chain ID (“3”) of the last packet Pa1), the control unit 40c causes the retention unit 20 to output the packet Pa2 to the server 200a(1) independently of the process number. Consequently, even when the server 200a(1) receives packets the number of which exceeds the credit number, the server 200a(1) may improve the packet processing efficiency by distributing the received packets to the virtual machines 50a depending on the chain ID.

It is to be noted that the counter unit 31 of the transfer unit 60b(1) increases the process number by one to count “4.”

On the other hand, though not illustrated in FIG. 10, even if the elapsed time period is equal to or longer than the time period at time t13, if the chain ID of the next packet Pa2 is “3” or the like, the control unit 40c outputs an instruction to the retention unit 20 to suppress outputting of the packet Pa2. For example, as illustrated in FIG. 10D, until a packet Pa0 outputted from the retention unit 20 to the server 200a(1) before the packet Pa1 is received from the server 200a(1), the control unit 40c causes the retention unit 20 to suppress outputting of the packet Pa2. When the transfer unit 60b(1) receives the packet Pa0, the counter unit 31 of the transfer unit 60b(1) decreases the process number by one to count “2.” Thus, since the process number is smaller than the credit number (“3”), the retention unit 20 outputs the packet Pa2 to the server 200a(1) under the control of the control unit 40c.

For example, the condition that the elapsed time period of the second measurement unit C2 is equal to or longer than the time period at time t13 and the substance of the communication process indicated by the chain ID of the next packet is lighter in process load than the substance of the communication process of the chain ID of the packet outputted last from the retention unit 20 is an example of the credit excess condition.

The threshold value calculation unit C3 calculates, using the process time period for each of the chain IDs measured by the first measurement unit C1, a period of time (process threshold value such as the time period at time t13) in which it is estimated from the elapsed time period of the second measurement unit C2 that, between each adjacent chain IDs, processing of one of the chain IDs ends in the server 200a.

It is to be noted that it is sometimes difficult for the threshold value calculation unit C3 to calculate a process threshold value between each adjacent chain IDs, for example, using the distributions PC1 and PC3 of the process time periods illustrated in FIG. 9. In this case, the threshold value calculation unit C3 does not calculate the process threshold value, and the control unit 40c controls outputting of a packet from the retention unit 20 to the server 200a based on the process number and the credit number.

It is to be noted that the process of the threshold value calculation unit C3 is executed while the switching apparatus 100c operates, and the threshold value calculation unit C3 may update the process threshold value between each adjacent chain IDs. Further, when a new virtual machine 50a (for example, a new communication process different from a communication process being executed) is executed in the server 200a(1), the threshold value calculation unit C3 may calculate a process threshold value with regard to the new chain ID. Alternatively, the threshold value calculation unit C3 may update the process threshold value between each adjacent chain IDs at given intervals of time based on time information outputted from the clock circuit of the switching apparatus 100c.

It is to be noted that the packet processing system SYS3 is not limited to the example depicted in FIG. 8. For example, the control unit 40c may be provided in each transfer unit 60b such that it controls operation of the transfer unit 60b. Further, the credit number may differ among different transfer units 60b.

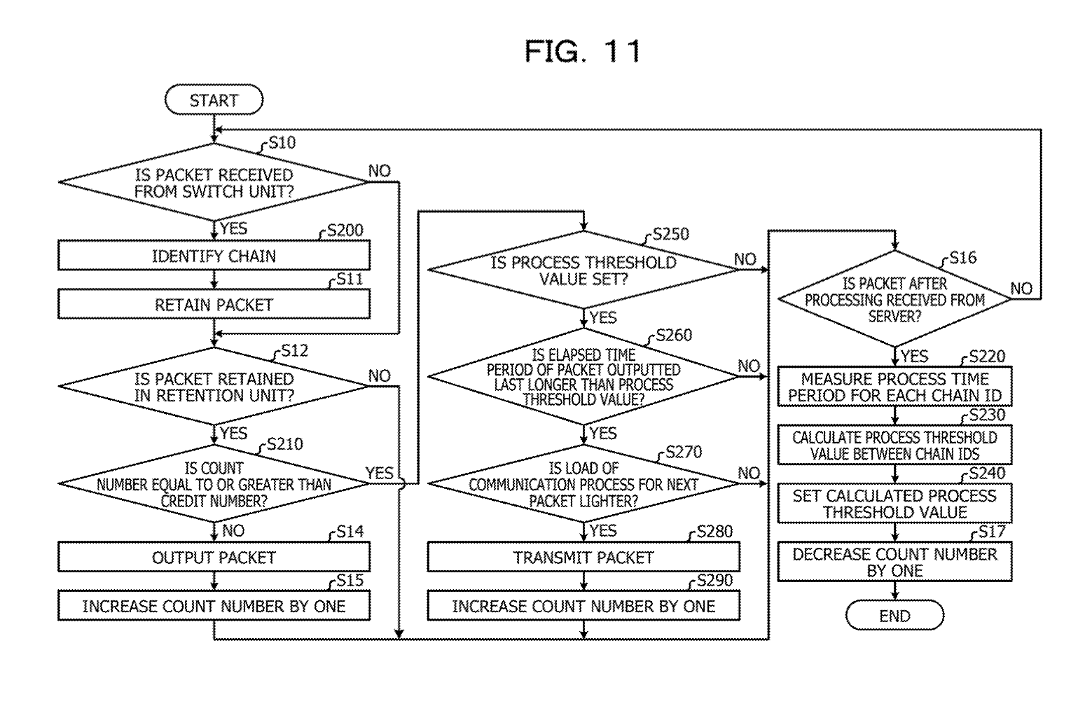

FIG. 11 illustrates an example of a switching process in the switching apparatus 100c depicted in FIG. 8. It is to be noted that, from among processes at steps depicted in FIG. 11, processes same as or similar to those at the steps described with reference to FIG. 4 are denoted by the same step numbers and detailed description of them is omitted herein. The process illustrated in FIG. 11 is implemented by operation of the switch unit 11, N transfer units 60b and control unit 40c incorporated in the switching apparatus 100c.

It is to be noted that the process illustrated in FIG. 11 indicates a case in which a packet is transferred between the transfer unit 60b(1) and the server 200a(1). A process similar to that illustrated in FIG. 11 is executed also where a packet is transferred between each of the transfer units 60b(2) to 60b(N) and a corresponding one of the servers 200a(2) to 200a(N).

The switching apparatus 100c executes a process at step S200 after it executes the process at step S10.

At step S200, the identification unit 15a identifies, based on the VID of the VLAN tag header added to the packet received at step S10 and the process table PT illustrated in FIG. 6, the chain of the received packet. Then, the identification unit 15a adds the identification number (chain ID) of the identification area IA of the process table PT illustrated in FIG. 6 and a serial number as information indicative of the identified chain to the packet. The identification unit 15a outputs the packet to which the chain ID and the serial number are added to the retention unit 20. After the process at step S200 is executed, the switching apparatus 100c executes processes at steps S11, S12 and S210. It is to be noted that, if a packet is retained in the retention unit 20 at step S12 illustrated in FIG. 11, the processing of the switching apparatus 100c advances to step S210.

At step S210, the control unit 40c decides whether or not the count number of the counter unit 31 of the transfer unit 60b(1) is equal to or greater than the credit number. If the count number is smaller than the credit number, the processing of the switching apparatus 100c advances to step S14. On the other hand, if the count number is equal to or greater than the credit number, the second measurement unit C2 starts measurement of the elapsed time period, and the processing of the switching apparatus 100c advances to step S250.

After the switching apparatus 100c executes the process at step S14, it successively executes processes at steps S15, S16 and S220.

At step S220, the first measurement unit C1 measures, for each chain ID, the process time period spent on a communication process of the packet in the server 200a(1). For example, the first measurement unit C1 acquires, the chain ID, serial number, timestamp of the transmission time, timestamp of the reception time and so forth of the packets from the IF unit 25. Then, the first measurement unit C1 measures the process time period from the difference between the timestamp of the reception time of the packet after processing and the timestamp of the transmission time of the packet outputted to the server 200a(1) to which packet the same serial number as the serial number of the packet after processing mentioned just above is added. The first measurement unit C1 outputs the measured process time period in an associated relationship with the chain ID of the packet to the threshold value calculation unit C3. After the process at step S220 is executed, the processing of the switching apparatus 100c advances to step S230.

At step S230, the threshold value calculation unit C3 calculates, from the process time period for each chain ID measured at step S220, a period of time (process threshold value) in which it is estimated from the elapsed time period of the second measurement unit C2 that, between each adjacent chain IDs, processing of one of the chain IDs ends in the server 200a(1). For example, the threshold value calculation unit C3 calculates an average value of the time periods of peaks in the distributions of the process time period between two chain IDs measured by the first measurement unit C1 as a process threshold value between the two chain IDs. After the process at step S230 is executed, the processing of the switching apparatus 100c advances to step S240.

At step S240, the control unit 40c sets the process threshold value between each adjacent chain IDs calculated at step S230 to the transfer unit 60b(1). For example, the control unit 40c stores the calculated process threshold values between each adjacent chain IDs in an associated relationship with the transfer unit 60(1) into the storage unit 70 or the like. After the process at step S240 is executed, the processing of the switching apparatus 100c advances to step S17.

On the other hand, at step S250, the control unit 40c decides whether or not the process threshold value between the chain ID of the packet outputted last from the retention unit 20 and the chain ID of the packet to be outputted subsequently from the retention unit 20 is set in the transfer unit 60b(1). If the process threshold value is set in the transfer unit 60b(1), the processing of the switching apparatus 100c advances to step S260. On the other hand, if the process threshold value is not set in the transfer unit 60b(1), the processing of the switching apparatus 100c advances to step S16.

At step S260, the control unit 40c decides whether or not the elapsed time period of the packet outputted last from the retention unit 20 is longer than the process threshold value. If the elapsed time period is longer than the process threshold value, the processing of the switching apparatus 100c advances to step S270. On the other hand, if the elapsed time period is equal to or shorter than the process threshold value, the processing of the switching apparatus 100c advances to step S16.

At step S270, the control unit 40c decides, based on the process time periods of the individual chain IDs measured at step S220, whether or not the load of the communication process of the chain ID of the packet to be outputted next from the retention unit 20 is lighter than the load of the communication process of the chain ID of the packet outputted last. For example, the control unit 40c decides whether or not the process time period regarding the chain ID of the packet to be outputted next from the retention unit 20 is shorter than the communication time period regarding the chain ID of the packet outputted last from the retention unit 20. Then, if the load of the communication process of the packet to be outputted next from the retention unit 20 is lighter than the load of the communication process of the packet outputted last, the processing of the switching apparatus 100c advances to step S280. On the other hand, if the load of the communication process of the packet to be outputted next from the retention unit 20 is equal to or heavier than the load of the communication process of the packet outputted last, the processing of the switching apparatus 100c advances to step S16.

At step S280, the control unit 40c causes the retention unit 20 of the transfer unit 60b(1) to output the packet retained at the top in the retention unit 20 to the server 200a(1). After the process at step S280 is executed, the processing of the switching apparatus 100c advances to step S290.

At step S290, the counter unit 31 of the transfer unit 60b(1) increases the count number by one. After the process at step S290 is executed, the processing of the switching apparatus 100c advances to step S16.

Then, the switching apparatus 100c repetitively executes the process illustrated in FIG. 11. It is to be noted that the processes at steps S10, S200, S11, S12, S210, S14, S15 and S250 to S290 and the processes at steps S16, S220, S230, S240 and S17 may be executed in parallel.

As described above, in the embodiment depicted in FIGS. 8 to 11, the counter unit 31 counts the process number of packets being executed by the server 200a from the difference between the number of packets outputted to the server 200a and the number of packets after processing received from the server 200a. Then, the control unit 40c controls outputting of packets from the retention unit 20 to the server 200a such that the process number in the server 200a may become equal to or smaller than the credit number that is the maximum number of packets processable by the server 200a. For example, the switching apparatus 100c controls outputting of a packet to the server 200a without receiving information indicating that the server 200a has no room in the processing capacity of packets from the server 200a. Consequently, even where the plurality of virtual machines 50a being executed in each server 200a do not have a function for requesting the switching apparatus 100c to stop transmission of a packet, the packet processing system SYS3 may control the transfer amount of packets by the switching apparatus 100c. As a result, the packet processing system SYS3 may suppress packet loss.

Further, when the credit excess condition is satisfied, the control unit 40c causes the retention unit 20 to output a next packet irrespective of the process number. It is to be noted that the credit excess condition is a condition that the communication process for a packet to be outputted next from the retention unit 20 is lighter in load than the communication process for a packet outputted last and besides the elapsed time period is longer than the process threshold value. Consequently, even when the server 200a receives packets the number of which exceeds the credit number, the packet processing efficiency may be improved by distributing the received packets to the virtual machines 50a depending on the chain ID (substance of the communication process).

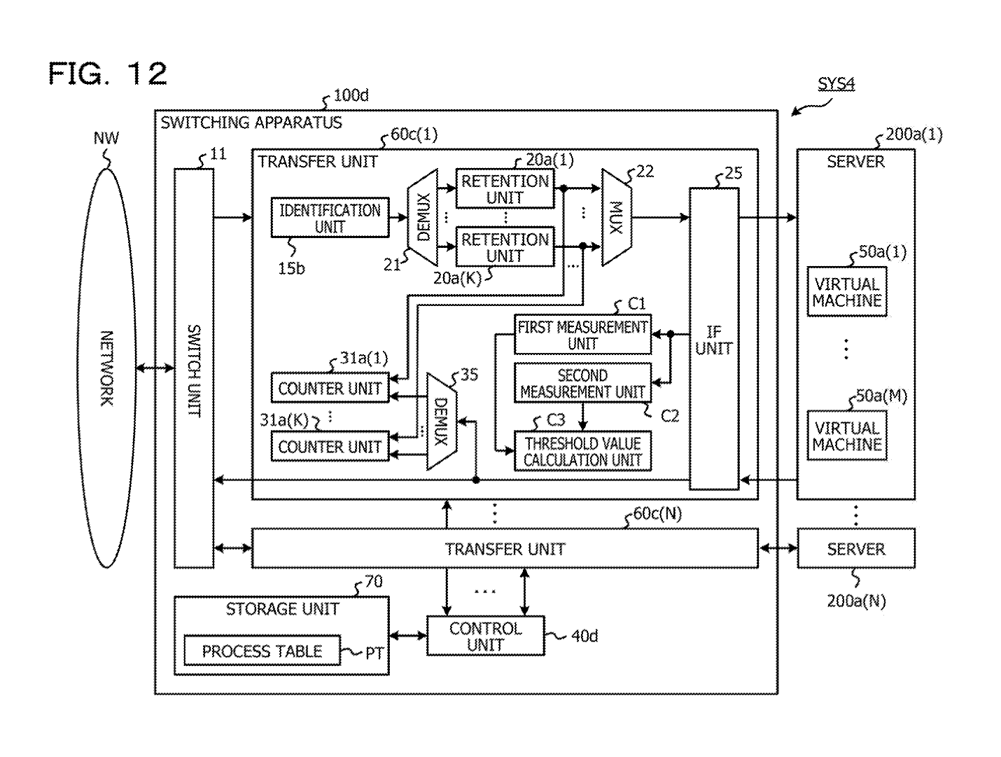

FIG. 12 depicts a yet further embodiment of a switching apparatus and a packet processing system. Elements having functions same as or similar to those of the elements described with reference to FIG. 5 or 8 are denoted by the same or like reference symbols, and detailed description of such elements is omitted herein.

A packet processing system SYS4 depicted in FIG. 12 includes a switching apparatus 100d and N servers 200a. The switching apparatus 100d is coupled to the N servers 200a and a network NW by wire or wireless coupling.

The switching apparatus 100d includes a switch unit 11, N transfer units 60c (60c(1) to 60c(N)), a control unit 40d and a storage unit 70.

The transfer unit 60c(1) includes an identification unit 15b, a DEMUX 21, K retention units 20a, a MUX 22, an IF unit 25, a DEMUX 35, K counter units 31a, a first measurement unit C1, a second measurement unit C2 and a threshold value calculation unit C3. It is to be noted that each of the transfer units 60c(2) to 60c(N) includes elements same as or similar to those of the transfer unit 60c(1) depicted in FIG. 12.

The identification unit 15b acquires a VID included in the VLAN tag header added to a received packet similarly, for example, to the identification unit 15 depicted in FIG. 5. The identification unit 15b refers to the process table PT through the control unit 40d and acquires the substance (chain) and the chain group of the communication process corresponding to the acquired VID. Then, the identification unit 15b adds the acquired chain group as information representative of the chain of the packet to the received packet.

Further, the identification unit 15b adds a serial number for identifying each packet to the packet similarly to the identification unit 15a depicted in FIG. 8. Further, the identification unit 15b adds the identification number of the identification area IA of the process table PT depicted in FIG. 6 corresponding to the acquired VID as a chain ID to the packet. Then, the identification unit 15b outputs the packet, to which the chain ID, serial number and chain group are added, to the DEMUX 21.

The control unit 40d is implemented, for example, by execution of a program stored in the storage unit 70 by a processor or the like included in the switching apparatus 100d, and controls operation of the switching apparatus 100d. Further, the control unit 40d controls outputting of a packet from each retention unit 20a in each transfer unit 60c to the server 200a based on the count number counted by each counter unit 31a similarly to the control unit 40b depicted in FIG. 5.

Further, the control unit 40d causes the retention unit 20a to output a packet to the server 200a when a credit excess condition is satisfied even if the count number of the counter unit 31a(1) is equal to or greater than the credit number similarly to the control unit 40c depicted in FIG. 8. Consequently, even when the server 200a receives packets the number of which exceeds the credit number, the packet processing efficiency may be improved by distributing the received packets to the virtual machines 50a depending on the chain ID.

It is to be noted that, also for the transfer units 60c(2) to 60c(N), the control unit 40d executes control same as or similar to that for the transfer unit 60c(1).

It is to be noted that the packet processing system SYS4 is not limited to the example depicted in FIG. 12. For example, the control unit 40d may be provided in each transfer unit 60c such that it controls operation of the transfer unit 60c. Further, the credit number may have a value different among the different transfer units 60c or may have a value different among the different retention units 20a (or counter units 31a).

The switching process in the switching apparatus 100d depicted in FIG. 12 is similar to that illustrated in FIG. 11, and detailed description of the switching process is omitted herein. It is to be noted that, at step S200 illustrated in FIG. 11, the identification unit 15b identifies the chain group of the received packet based on the VID of the VLAN tag header added to the packet received at step S10 and the process table PT illustrated in FIG. 6. Then, the identification unit 15b adds the identified chain group, the identification number (chain ID) of the identification area IA of the process table PT illustrated in FIG. 6 and the serial number to the packet. Then, the identification unit 15b outputs the packet to the DEMUX 21.

Further, at step S210, the control unit 40d decides whether or not the count number of the counter unit 31a of the chain group with regard to which it is decided at step S11 that the retention unit 20a retains a packet is equal to or greater than the credit number. If the count number is smaller than the credit number, the processing of the switching apparatus 100d advances to step S14. On the other hand, if the count number is equal to or greater than the credit number, the processing of the switching apparatus 100d advances to step S250.

At step S260, the control unit 40d decides whether or not the elapsed time period of a packet outputted last from the retention unit 20a of the chain group with regard to which it is decided at step S210 that the count number is equal to or greater than the credit number is longer than the process threshold value. If the elapsed time period is longer than the process threshold value, the processing of the switching apparatus 100d advances to step S270. On the other hand, if the elapsed time period is equal to or shorter than the process threshold value, the processing of the switching apparatus 100d advances to step S16.

Further, at step S270, the control unit 40d decides whether or not the load of the communication process of a packet to be outputted next from the retention unit 20a of the chain group with regard to which it is decided at step S260 that the elapsed time period is longer than the process threshold value is lighter than the load of the communication process of the packet outputted last. If the load of the communication process of the packet to be outputted next is lighter, the processing of the switching apparatus 100d advances to step S280. On the other hand, if the load of the communication process of the packet to be outputted next is equal to or heavier than the load of the communication process of the packet outputted last, the processing of the switching apparatus 100d advances to step S16.

Further, at step S280, the control unit 40d causes the retention unit 20a of the chain group, with regard to which it is decided at step S270 that the load of the communication process of a packet to be outputted next is lighter, to output the packet retained at the top of the retention unit 20a to the server 200a(1). After the process at step S280 is executed, the processing of the switching apparatus 100d advances to step S290.

Then, the switching apparatus 100d repetitively executes the process illustrated in FIG. 11. It is to be noted that the processes at steps S10, S200, S11, S12, S210, S14, S15 and S250 to S290 and the processes at steps S16, S220, S230, S240 and S17 may be executed in parallel to each other.

As described above, in the embodiment depicted in FIG. 12, each counter unit 31a calculates, for each chain group (substance of the communication process), the process number of packets for which a communication process is being executed in the server 200a. Then, the control unit 40d controls outputting of a packet from each retention unit 20a to the server 200a such that the process number for each chain group may be equal to or smaller than the credit number that is the maximum number of packets processable by the server 200a. For example, the switching apparatus 100d controls outputting of a packet to the server 200a without receiving information indicating that the server 200a has no room in the processing capacity of packets from the server 200a. Consequently, even where the plurality of virtual machines 50a being executed in each server 200a do not have a function for requesting the switching apparatus 100d to stop transmission of a packet, the packet processing system SYS4 may control the transfer amount of packets by the switching apparatus 100d. As a result, the packet processing system SYS4 may suppress packet loss.

Further, since the process load in the server 200a differs among different chain groups, the control unit 40d controls outputting of a packet from each retention unit 20a to the server 200a based on the process number of each counter unit 31a and the credit number of each chain group. Consequently, the switching apparatus 100d may transfer a packet more efficiently than where the single counter unit 31 depicted in FIG. 8 counts the number of packets, and the processing efficiency of packets in the packet processing system SYS4 may be improved.

Further, where the credit excess condition is satisfied, the control unit 40d causes the retention unit 20a to output a next packet irrespective of the process number. It is to be noted that the credit excess condition is a condition that the communication process for a packet to be outputted next from the retention unit 20 is lighter in load than the communication process for a packet outputted last and besides the elapsed time period is longer than the process threshold value. Consequently, even when the server 200a receives packets the number of which exceeds the credit number, the packet processing efficiency may be improved by distributing the received packets to the virtual machines 50a depending on the chain ID (substance of the communication process).

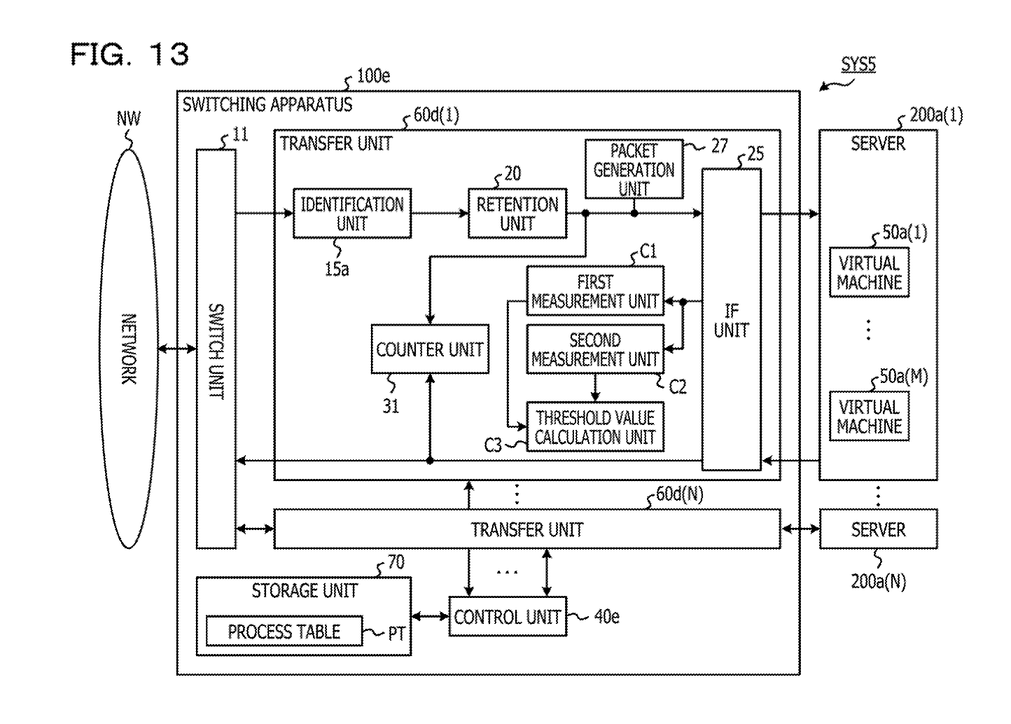

FIG. 13 depicts a different embodiment of a switching apparatus and a packet processing system. Elements having functions same as or similar to those of the elements described with reference to FIG. 8 are denoted by the same or like reference symbols, and detailed description of such elements is omitted herein.

A packet processing system SYS5 depicted in FIG. 13 includes a switching apparatus 100e and N servers 200a. The switching apparatus 100e is coupled to the N servers 200a and a network NW through wire or wireless coupling.

The switching apparatus 100e includes a switch unit 11, N transfer units 60d (60d(1) to 60d(N)), a control unit 40e and a storage unit 70.

The transfer unit 60d(1) includes an identification unit 15a, a retention unit 20, an IF unit 25, a packet generation unit 27, a counter unit 31, a first measurement unit C1, a second measurement unit C2 and a threshold value calculation unit C3. For example, the transfer unit 60d is configured by adding the packet generation unit 27 to the transfer unit 60b depicted in FIG. 8. It is to be noted that each of the transfer units 60d(2) to 60d(N) includes elements same as or similar to those of the transfer unit 60d(1) depicted in FIG. 13.

The packet generation unit 27 operates in the transfer unit 60d(1) and generates a pseudo packet for causing the server 200a(1) to artificially execute a process for each chain ID (substance of the communication process). The pseudo packet is a dummy packet used by the first measurement unit C1 to measure the process time period for each chain ID.

The control unit 40e is implemented, for example, by execution of a program stored in the storage unit 70 by a processor or the like included in the switching apparatus 100e and controls operation of the switching apparatus 100e. Then, the control unit 40e controls outputting of a packet to the server 200a from the retention unit 20 in each transfer unit 60d based on the count number counted by the counter unit 31 similarly to the control unit 40c depicted in FIG. 8.

Further, even if the count number of the counter unit 31 is equal to or greater than the credit number, if a given condition is satisfied, the control unit 40e causes the retention unit 20 of the transfer unit 60d to output a packet to the server 200a similarly to the control unit 40c depicted in FIG. 8.

Furthermore, for example, before the packet processing system SYS5 executes a communication process for a packet to be transferred to or from the network NW, the control unit 40e outputs an instruction to the packet generation unit 27 of each transfer unit 60d to generate a pseudo packet of each chain ID. Then, the control unit 40e outputs an instruction to the packet generation unit 27 to output the generated pseudo packet of each chain ID to the server 200a. The first measurement unit C1 of each transfer unit 60d measures the process time period for each chain ID. The threshold value calculation unit C3 of each transfer unit 60d calculates a process threshold value (for example, the time period at time t13 depicted in FIG. 9 or the like) between each adjacent chain IDs based on the distribution of the process time period regarding each chain ID measured by the first measurement unit C1. The control unit 40e stores, for example, the process threshold value between each adjacent chain IDs calculated in each transfer unit 60d in an associated relationship with a corresponding one of the transfer units 60d into the storage unit 70 or the like. For example, the control unit 40e sets the calculated process threshold value between each adjacent chain IDs to each transfer unit 60d.

It is to be noted that, even when the packet processing system SYS5 is executing a communication process for a packet to be transmitted to or from the network NW, the control unit 40e may cause the packet generation unit 27 to generate a pseudo packet and the threshold value calculation unit C3 may update the process threshold value between each adjacent chain IDs. For example, in the packet processing system SYS5, when the reception number of packets of a given chain ID from the network NW is smaller than the reception number of packets of the other chain IDs, it is sometimes difficult for the threshold value calculation unit C3 to update the process threshold value for the given chain ID. In this case, the control unit 40e may cause, for example, the packet generation unit 27 to generate a pseudo packet of the given chain ID whose reception number is small, and the threshold value calculation unit C3 may update the process threshold value of the given chain ID using a generated packet signal.

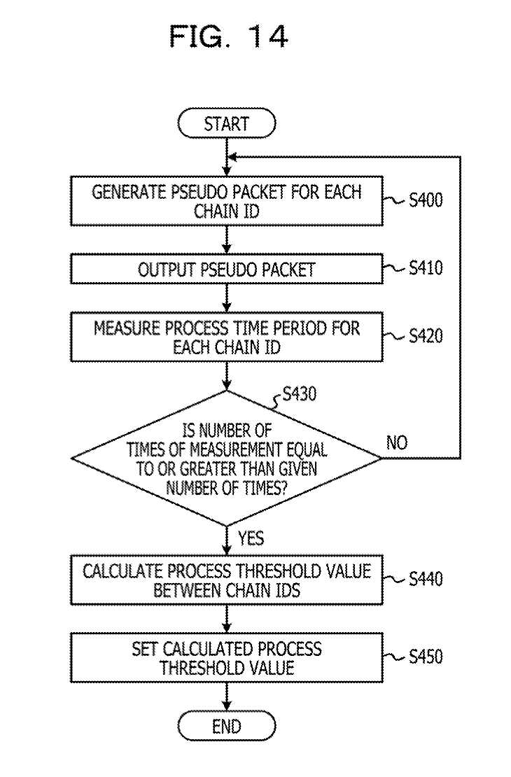

FIG. 14 illustrates an example of a setting process of a process threshold value in the packet processing system SYS5 depicted in FIG. 13. Processes at the steps illustrated in FIG. 14 are implemented by operation of the switch unit 11, N transfer units 60d and control unit 40e incorporated in the switching apparatus 100e.

It is to be noted that the process illustrated in FIG. 14 indicates a case where a pseudo packet is transferred between the transfer unit 60d(1) and the server 200(1). Also where a pseudo packet is transferred between each of the transfer units 60d(2) to 60d(N) and a corresponding one of the servers 200a(2) to 200a(N), a process similar to the process illustrated in FIG. 14 is executed.

Further, the process illustrated in FIG. 14 is executed before the packet processing system SYS5 executes a packet process. However, the process illustrated in FIG. 14 may be executed in parallel to the packet process in the packet processing system SYS5.

At step S400, the packet generation unit 27 generates a pseudo packet for each chain ID under the control of the control unit 40e. After the process at step S400 is executed, the processing of the switching apparatus 100e advances to step S410.

At step S410, the packet generation unit 27 successively outputs pseudo packets of the chain IDs generated at step S400 to the server 200a(1). After the process at step S410 is executed, the processing of the switching apparatus 100e advances to step S420.

At step S420, the first measurement unit C1 measures, for each chain ID, a process time period of a communication process in the server 200a(1) for the pseudo packet outputted at step S410 in a same or similar manner as the process at step S220 illustrated in FIG. 11. After the process at step S420 is executed, the processing of the switching apparatus 100e advances to step S430.

At step S430, the control unit 40e decides whether or not the number of times of measurement of the process time period for each chain ID by the first measurement unit C1 at step S420 is equal to or greater than a given number of times. If the number of times of measurement of the process time period for each chain ID is smaller than the given number of times, the processing of the switching apparatus 100e advances to step S400. On the other hand, if the number of times of measurement of the process time period for each chain ID is equal to or greater than the given number of times, the processing of the switching apparatus 100e advances to step S440. The given number of times may be once and is preferably determined in response to the magnitude of fluctuations in the process time period in each virtual machine 50a or the like.

At step S440, the threshold value calculation unit C3 calculates, based on the process time period for each chain ID measured at step S420, the process threshold value for each chain ID between each adjacent chain IDs in a same or similar manner as in the process at step S230 illustrated in FIG. 11. After the process at step S440 is executed, the processing of the switching apparatus 100e advances to step S450.

At step S450, the control unit 40e sets the process threshold values calculated at step S440 to the transfer unit 60d(1). Then, the switching apparatus 100e ends the setting process of a process threshold value.

It is to be noted that the switching process in the switching apparatus 100e depicted in FIG. 13 is similar to the process illustrated in FIG. 11, and detailed description is omitted herein. It is to be noted that, in the packet processing system SYS5 depicted in FIG. 13, the setting process of a process threshold value illustrated in FIG. 14 is executed before the switching apparatus 100e executes a switching process. Therefore, in the switching process in the switching apparatus 100e, the processes at steps S220 to S240 from within the process illustrated in FIG. 11 may be omitted.

It is to be noted that the packet processing system SYS5 is not limited to the example depicted in FIG. 13. For example, the switching apparatus 100e may include the transfer unit 60c depicted in FIG. 12, in which the packet generation unit 27 depicted in FIG. 13 is disposed, in place of the transfer unit 60d. The setting process of a process threshold value in the packet processing system SYS5 in this case is executed in a same or similar manner as the process illustrated in FIG. 14. Further, the switching process in the switching apparatus 100e in this case is executed similarly to the switching process illustrated in FIG. 11. It is to be noted that, when the setting process of a process threshold value illustrated in FIG. 14 is executed before the process illustrated in FIG. 11 is executed, the processes at steps S220 to S240 from within the process illustrated in FIG. 11 may be omitted.

As described above, in the embodiment depicted in FIGS. 13 and 14, the counter unit 31 counts the process number of packets being executed by the server 200a from the difference between the number of packets outputted to the server 200a and the number of packets after processing received from the server 200a. Then, the control unit 40e controls outputting of a packet from the retention unit 20 to the server 200a such that the process number in the server 200a may be equal to or smaller than the credit number that is the maximum number of packets processable by the server 200a. For example, the switching apparatus 100e controls outputting of a packet to the server 200a without receiving information indicating that the server 200a has no room in the processing capacity of packets from the server 200a. Consequently, even where the plurality of virtual machines 50a being executed in each server 200a do not have a function for requesting the switching apparatus 100e to stop transmission of a packet, the packet processing system SYS5 may control the transfer amount of packets by the switching apparatus 100e. As a result, the packet processing system SYS5 may suppress packet loss.

Further, when the credit excess condition is satisfied, the control unit 40e causes the retention unit 20 to output a next packet irrespective of the process number. It is to be noted that the credit excess condition is a condition that the communication process for a packet to be outputted next from the retention unit 20 is lighter in load than the communication process for a packet outputted last and besides the elapsed time period is longer than the process threshold value. Consequently, even when the server 200a receives packets the number of which exceeds the credit number, the server 200a may improve the processing efficiency of packets by distributing the received packets to the virtual machines 50a depending on the chain ID (substance of the communication process).

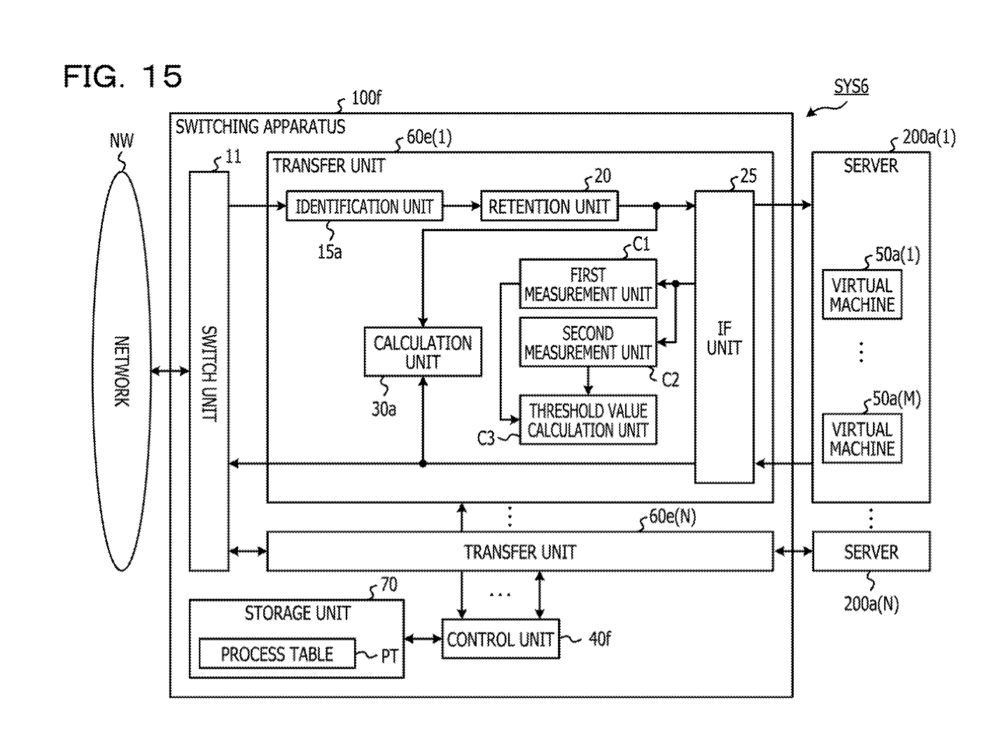

FIG. 15 depicts another different embodiment of a switching apparatus and a packet processing system. Elements having functions same as or similar to those of the elements described with reference to FIG. 8 are denoted by the same or like reference symbols, and detailed description of such elements is omitted herein.

A packet processing system SYS6 depicted in FIG. 15 includes a switching apparatus 100f and N servers 200a. The switching apparatus 100f is coupled to the N servers 200a and a network NW through wire or wireless coupling.

The switching apparatus 100f includes a switch unit 11, N transfer units 60e (60e(1) to 60e(N)), a control unit 40f and a storage unit 70.

The transfer unit 60e(1) includes an identification unit 15a, a retention unit 20, an IF unit 25, a calculation unit 30a, a first measurement unit C1, a second measurement unit C2 and a threshold value calculation unit C3. For example, the transfer unit 60e(1) includes the calculation unit 30a in place of the counter unit 31 depicted in FIG. 8. It is to be noted that also each of the transfer units 60e(2) to 60e(N) includes elements same as or similar to those of the transfer unit 60e(1) depicted in FIG. 15.

The calculation unit 30a determines, for example, if the retention unit 20 outputs a packet to the server 200a(1), a data amount to be used for a communication process from among packets (the data amount is hereinafter referred to also as output data amount) based on a chain ID or a chain group added to the packet. On the other hand, if the calculation unit 30a receives a packet after processing from the server 200a(1), the calculation unit 30a determines a data amount used in a communication process (the data amount is hereinafter referred to also as reception data amount) based on a chain ID or a chain group added to the received packet after processing. Then, the calculation unit 30a calculates a data amount of packets for which a communication process is being executed in the server 200a(1) (the data amount is hereinafter referred to also as process data amount) based on the calculated output data amount and reception data amount.

For example, if a chain ID or a chain group added to a packet indicates a communication process of routing, an IP address of a transmission source and an IP address of a destination stored in the packet are used for the communication process of routing. In this case, the calculation unit 30a determines the amount of data of the IP addresses of the transmission source and the destination as an output data amount and a reception data amount, respectively. Further, where the chain ID or the chain group added to the packet indicates a communication process of IPsec, data stored in the data field of the packet is used in the communication process of IPsec. In this case, the calculation unit 30a determines the amount of data stored in the data field of the packet as an output data amount or a reception data amount.

The control unit 40f is implemented, for example, by execution of a program stored in the storage unit 70 by a processor or the like included in the switching apparatus 100f and controls operation of the switching apparatus 100f. Then, the control unit 40f controls outputting of a packet from the retention unit 20 to the server 200a(1) based on the process data amount calculated by the calculation unit 30a.

For example, the control unit 40f decides whether or not the sum of the output data amount of a packet to be outputted from the retention unit 20 and the process data amount being processed in the server 200a(1) is equal to or greater than the maximum data amount processable by the server 200a(1). In the following description, the maximum data amount processable by the server 200a(1) is referred to also as credit amount. If the sum of the output data amount of the packet to be outputted next from the retention unit 20 and the process data amount being processed by the server 200a(1) is smaller than the credit amount, the control unit 40f causes the retention unit 20 to output the packet to the server 200a(1). On the other hand, if the sum of the output data amount of the packet to be outputted next from the retention unit 20 and the process data amount is equal to or greater than the credit amount, the control unit 40f outputs an instruction to the retention unit 20 to suppress outputting of the packet to the server 200a(1). In this manner, the control unit 40f controls outputting of a packet from the retention unit 20 to the server 200a(1) such that the sum of the output data amount of a packet to be outputted next from the retention unit 20 and the process data amount becomes equal to or smaller than the credit amount.

It is to be noted that, if the credit excess condition is satisfied, the control unit 40f causes the retention unit 20 to output a packet to the server 200a irrespective of the process data amount to which the output data amount of a packet to be outputted next from the retention unit 20 is added similarly to the control unit 40c depicted in FIG. 8. For example, when the communication process of a packet to be outputted next from the retention unit 20 is lighter in load than the communication process of a packet outputted last and besides the elapsed time period is longer than the process threshold value, the control unit 40f may cause the retention unit 20 to output a packet to the server 200a.

It is to be noted that the packet processing system SYS6 is not limited to the example depicted in FIG. 15. For example, in the switching apparatus 100 depicted in FIG. 1, the calculation unit 30a depicted in FIG. 15 may be disposed in place of the calculation unit 30. Further, in the switching apparatus 100a depicted in FIG. 3, the calculation unit 30a depicted in FIG. 15 may be disposed in place of the counter unit 31. Further, in the switching apparatus 100b depicted in FIG. 5, K such calculation units 30a as depicted in FIG. 15 may be disposed in place of the K counter units 31a. Further, in the switching apparatus 100c depicted in FIG. 8, the calculation unit 30a depicted in FIG. 15 may be disposed in place of the counter unit 31. Further, in the switching apparatus 100d depicted in FIG. 12, K such calculation units 30a as depicted in FIG. 15 may be disposed in place of the K counter units 31a. Further, in the switching apparatus 100e depicted in FIG. 13, the calculation unit 30a depicted in FIG. 15 may be disposed in place of the counter unit 31.

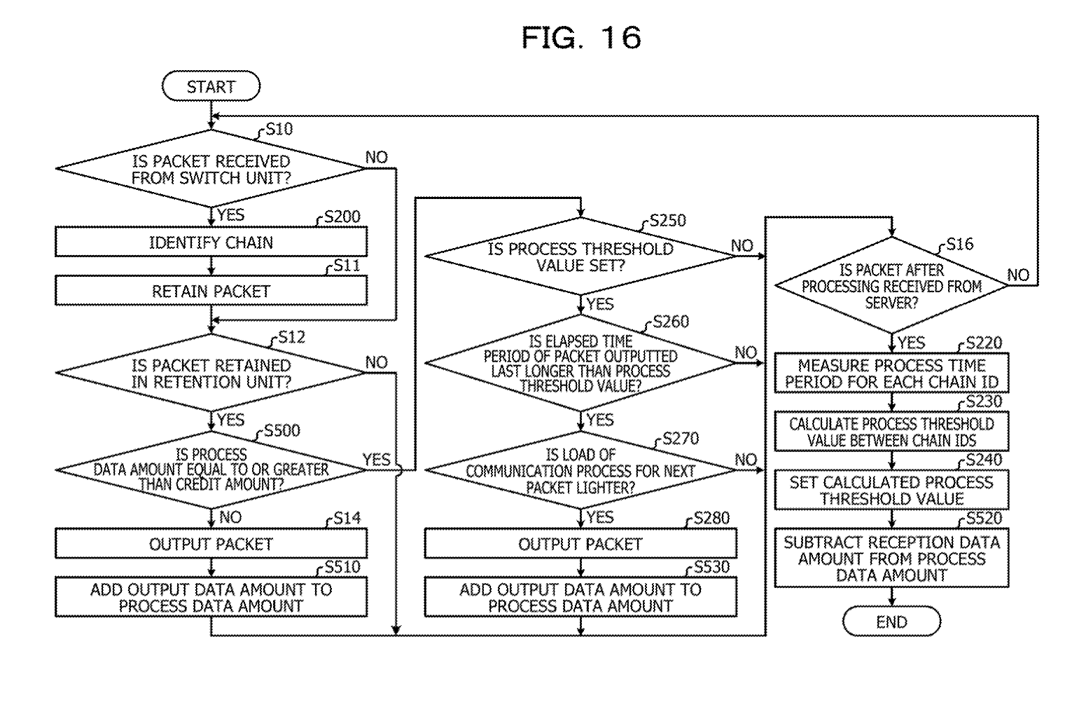

FIG. 16 illustrates an example of a switching process in the switching apparatus 100f depicted in FIG. 15. It is to be noted that, from among processes at steps depicted in FIG. 16, processes same as or similar to those at the steps described with reference to FIG. 11 are denoted by the same step numbers and detailed description of them is omitted herein. For example, in the process illustrated in FIG. 16, processes at steps S500, S510, S520 and S530 are executed in place of the processes at steps S210, S15, S17 and S290 illustrated in FIG. 11.

At step S500, the control unit 40f decides whether or not, in the transfer unit 60e(1), the process data amount to which the output data amount of a packet to be outputted next from the retention unit 20 is added is equal to or greater than the credit amount. If the process data amount to which the output data amount of a next packet is added is equal to or greater than the credit amount, the processing of the switching apparatus 100f advances to step S250. On the other hand, if the process data amount to which the output data amount of the next packet is added is smaller than the credit amount, the processing of the switching apparatus 100f advances to step S14.

At step S510, the calculation unit 30a of the transfer unit 60e(1) adds the output data amount of the packet outputted at step S14 to the process data amount.

At step S520, the calculation unit 30a of the transfer unit 60e(1) subtracts the reception data amount of a packet after processing received at step S16 from the process data amount, and ends the processing.

At step S530, the calculation unit 30a of the transfer unit 60e(1) adds the output data amount of the packet outputted at step S280 to the process data amount. After the process at step S530 is executed, the processing of the switching apparatus 100f advances to step S16.

Then, the switching apparatus 100f repetitively executes the process illustrated in FIG. 16. It is to be noted that the processes at steps S10, S200, S11, S12, S500, S14, S510, S250 to S280 and S530 and the processes at steps S16, S220 to S240 and S520 may be executed in parallel.

It is to be noted that the process illustrated in FIG. 16 indicates a case in which a packet is transferred between the transfer unit 60e(1) and the server 200a(1). A process same as or similar to that illustrated in FIG. 16 is executed also where a packet is transferred between each of the transfer units 60e(2) to 60e(N) and a corresponding one of the servers 200a(2) to 200a(N).

As described above, in the embodiment depicted in FIGS. 15 and 16, the calculation unit 30a calculates a process data amount of packets being executed by the server 200a from the output data amount of an outputted packet and the reception data amount of a packet received from the server 200a. Then, the control unit 40f controls outputting of a packet from the retention unit 20 to the server 200a such that the process data amount to which the output data amount of a packet to be outputted next from the retention unit 20 is added becomes equal to or smaller than the credit amount that is the maximum data amount processable in the server 200a. For example, the switching apparatus 100f controls outputting of a packet to the server 200a without receiving information indicating that the server 200a has no room in the processing capacity of packets from the server 200a. Consequently, even where the plurality of virtual machines 50a being executed in each server 200a do not have a function for requesting the switching apparatus 100f to stop transmission of a packet, the packet processing system SYS6 may control the transfer amount of packets by the switching apparatus 100f. As a result, the packet processing system SYS6 may suppress packet loss.

Further, when the credit excess condition is satisfied, the control unit 40f causes the retention unit 20 to output a packet irrespective of the process data amount. It is to be noted that the credit excess condition is a condition that the communication process for a packet to be outputted next from the retention unit 20 is lighter in load than the communication process for a packet outputted last and besides the elapsed time period is longer than the process threshold value. Consequently, even when the server 200a receives packets the number of which exceeds the credit number, the server 200a may improve the processing efficiency of packets by distributing the received packets to the virtual machines 50a depending on the chain ID (substance of the communication process).

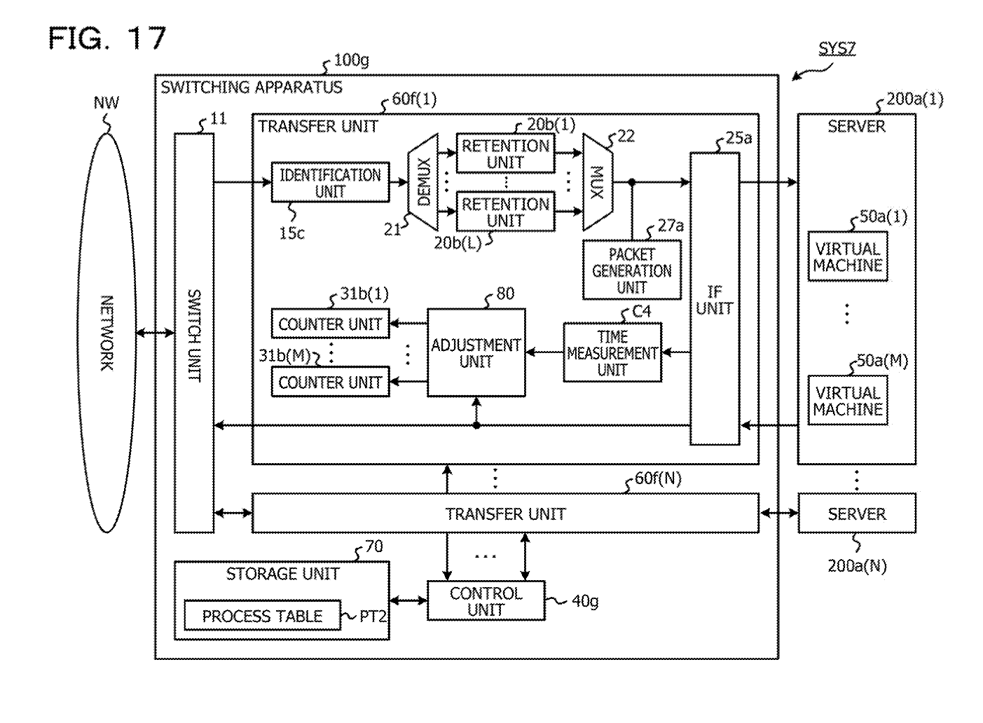

FIG. 17 depicts a further different embodiment of a switching apparatus and a packet processing system. Elements having functions same as or similar to those of the elements described with reference to FIG. 12 or 13 are denoted by the same or like reference symbols, and detailed description of such elements is omitted herein.

A packet processing system SYS7 depicted in FIG. 17 includes a switching apparatus 100g and N servers 200a. The switching apparatus 100g is coupled to the N servers 200a and a network NW through wire or wireless coupling.

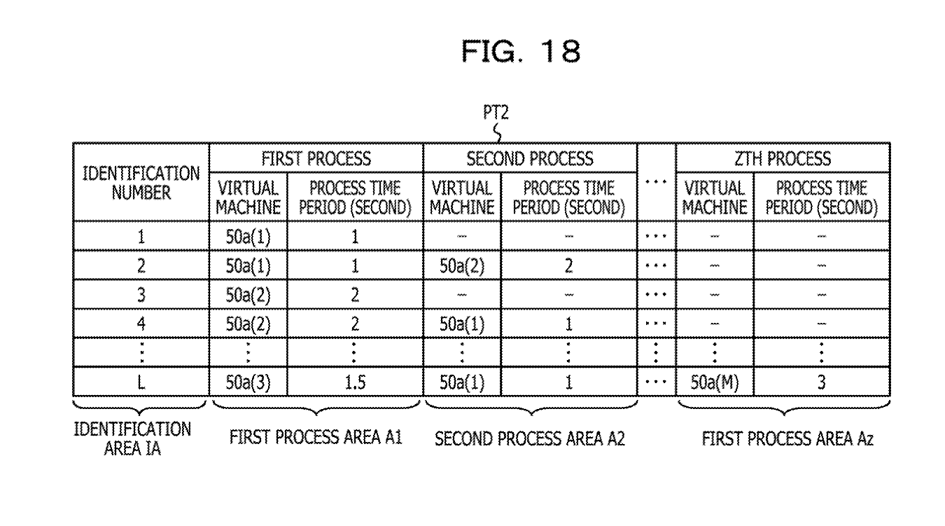

The switching apparatus 100g includes a switch unit 11, N transfer units 60f (60f(1) to 60f(N)), a control unit 40g and a storage unit 70. The storage unit 70 includes a storage area for storing a process table PT2 in place of the process table PT illustrated in FIG. 12. The process table PT2 is described with reference to FIG. 18.

The transfer unit 60f(1) includes an identification unit 15c, a DEMUX 21, L retention units 20b (20b(1) to 20b(L)), a MUX 22, an IF unit 25a, a packet generation unit 27a, M counter units 31b (31b(1) to 31b(M)), a time measurement unit C4 and an adjustment unit 80. Each of the transfer units 60f(2) to 60f(N) includes elements same as or similar to those of the transfer unit 60f(1) depicted in FIG. 17.

The identification unit 15c acquires the VID included in the VLAN tag header added to a received packet, for example, similarly to the identification unit 15 depicted in FIG. 5. The identification unit 15c refers to the process table PT2 stored in the storage unit 70 through the control unit 40g and acquires an identification number (chain ID) corresponding to the acquired VID, the substance (chain) of the communication process and an order of processes. Then, the identification unit 15c adds the acquired chain ID as information indicative of the chain of the packet to the received packet.

Further, the identification unit 15c adds information of a serial number or the like for identifying each packet to the packet. Then, the identification unit 15c outputs the packet to which the chain ID and the serial number are added to the DEMUX 21.

Each retention unit 20b is a memory having a first-in-first-out function such as a queue. Each retention unit 20b retains packets distributed by the DEMUX 21 and having the same chain ID (substance of the communication process) in order. Each retention unit 20b outputs the packets in the retention order to the server 200a(1). It is to be noted that the substance of the communication process includes information of a combination of communication processes and an order in which the communication processes are executed, and L substances are available. Therefore, the L retention units 20b are provided in each transfer unit 60f.

The IF unit 25a outputs a packet received from the retention unit 20b to the server 200a(1) and outputs a packet after processing received from the server 200a(1) to the switch unit 11 similarly to the IF unit 25 depicted in FIG. 13. Further, the IF unit 25a refers, for example, to information indicative of time outputted from a clock circuit included in the switching apparatus 100g or the like and acquires time information such as a timestamp that indicates transmission time at which a packet received from the retention unit 20b is outputted to the server 200a(1). The IF unit 25a outputs the chain ID and the serial number added to the packet and the acquired time information to the time measurement unit C4.

Further, the IF unit 25a refers, for example, to the information indicative of time outputted from the clock circuit of the switching apparatus 100g or the like and acquires time information such as a timestamp indicative of reception time at which a packet after processing is received from the server 200a(1). The IF unit 25a outputs time information at which the packet after processing is received and the chain ID and the serial number added to the packet after processing to the time measurement unit C4.

The packet generation unit 27a generates a pseudo packet for causing each of the virtual machines 50a of the server 200a(1) to execute a process artificially. The pseudo packet is a dummy packet used by the time measurement unit C4 to measure the process time period of each virtual machine 50a.

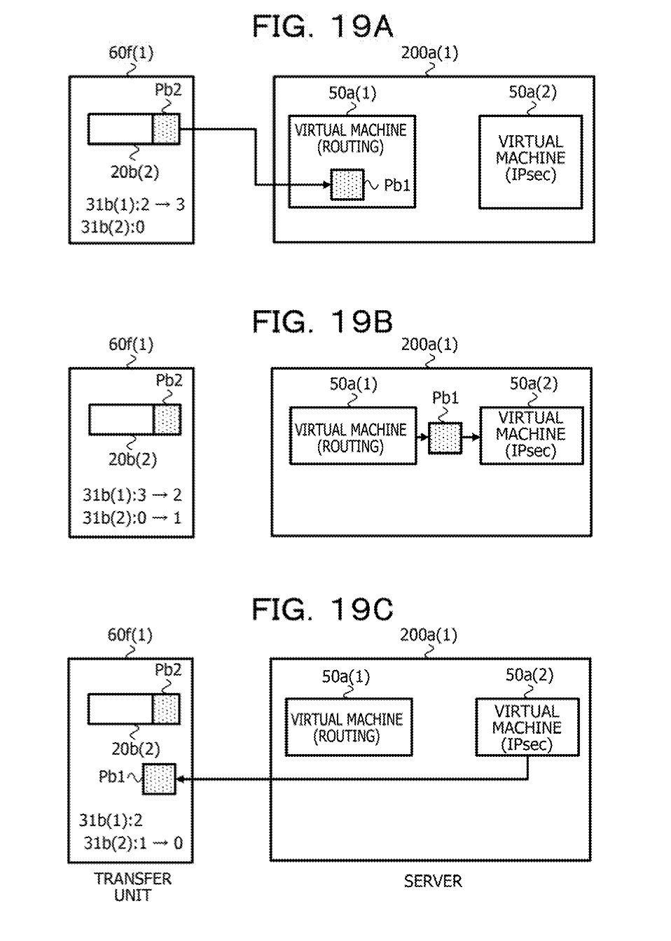

The counter units 31b(1) to 31b(M) are similar to the counter units 31a depicted in FIG. 12 except that the counter units 31b(1) to 31b(M) are provided in a corresponding relationship to the virtual machines 50a(1) to 50a(M) and they operate under the control of the adjustment unit 80. For example, the counter units 31b(1) to 31b(M) count the number of packets (process number) being processed in the virtual machines 50a(1) to 50a(M), respectively. Operation of each counter unit 31b is described with reference to FIG. 19.

The time measurement unit C4 measures an elapsed time period after each of packets is outputted from the retention unit 20b to the server 200a(1). For example, the time measurement unit C4 measures the elapsed time period from the time at which the retention unit 20b outputs the packet using information indicative of the time outputted from the clock circuit of the switching apparatus 100g or the like and a timestamp of transmission time of the packet acquired from the IF unit 25a. The time measurement unit C4 outputs the measured elapsed time period in an associated relationship with the chain ID and the serial number of the packet to the adjustment unit 80.

Further, the time measurement unit C4 measures a process time period spent on a communication process of a packet in each of the virtual machines 50a of the server 200a(1) using a pseudo packet generated by the packet generation unit 27a. For example, the packet generation unit 27a generates a pseudo packet to which a chain ID and a serial number for allowing processing by a single virtual machine 50a are added and outputs the generated pseudo packet to the server 200a(1). The time measurement unit C4 acquires the chain ID, serial number and timestamp of the transmission time of the outputted pseudo packet from the IF unit 25a. Further, the time measurement unit C4 acquires the chain ID, serial number and timestamp of the reception time of the pseudo packet after processing received from the server 200a(1) from the IF unit 25a. Then, the time measurement unit C4 calculates the difference between the timestamp of the reception time and the timestamp of the transmission time of pseudo packets to which the same serial number is added and measures the process time period of each virtual machine 50a. The time measurement unit C4 outputs the measured process time period of each virtual machine 50a to the adjustment unit 80.

It is to be noted that the time measurement unit C4 may measure the process time period of each virtual machine 50a using a packet received from the network NW.

The adjustment unit 80 specifies in which virtual machine 50a a packet outputted from each retention unit 20b is being processed using the elapsed time period, measured by the time measurement unit C4, of a packet outputted from each retention unit 20b, the chain ID of the packet and the process table PT2. The adjustment unit 80 adjusts, based on the result of the specification, the process number of each virtual machine 50a counted by the counter unit 31b. Operation of the adjustment unit 80 is described with reference to FIG. 19.

The control unit 40g is implemented, for example, by execution of a control program stored in the storage unit 70 by a processor or the like included in the switching apparatus 100g, and controls operation of the switching apparatus 100g. Then, the control unit 40g controls outputting of a packet from each retention unit 20b of the transfer unit 60f(1) to the server 200a based on the process number of each virtual machine 50a counted by each counter unit 31b. Operation of the control unit 40g is described with reference to FIG. 19.

It is to be noted that, also for the transfer units 60f(2) to 60f(N), the control unit 40g performs control same as or similar to that for the transfer unit 60f(1).

It is to be noted that the packet processing system SYS7 is not limited to the example depicted in FIG. 17. For example, the control unit 40g may be provided in each transfer unit 60f such that it controls operation of the transfer unit 60f. Further, the storage unit 70 may store the process table PT2 for each transfer unit 60f.

FIG. 18 illustrates an example of the process table PT2 depicted in FIG. 17. The process table PT2 includes a plurality of entries each including an identification area IA for retaining an identification number and a first process area A1 to a zth process area Az that retain the substance of first to zth processes, respectively.

In the identification area IA, a value of the VID for specifying a VLAN to which a packet belongs is stored as an identification number in a same or similar manner as in the process table PT illustrated in FIG. 6. The value of the VID is included in the VLAN tag header added to a packet received from the network NW. It is to be noted that, in the identification area IA, an IP address, a MAC address or the like indicative of a transmission destination or a transmission source of the received packet may be stored in place of the VID.

Each of the process areas from the first process area A1 to the zth process area Az retains information indicative of a virtual machine by which a communication process is executed and information indicative of a process time period of the communication process. The information retained in each of the process areas from the first process area A1 to the zth process area Az is retained in an order in accordance with the substance of the communication process executed for each packet having a VID (identification number). For example, where the communication process executed for a packet whose identification number is “1” is routing and the virtual machine 50a(1) is executing a routing process, information indicative of the virtual machine 50a(1) is stored in the first process area A1. Further, in the first process area A1, a process time period (for example, one second) of the virtual machine 50a(1) spent on a process of routing of a pseudo packet and measured by the time measurement unit C4 using a pseudo packet generated by the packet generation unit 27a is stored. It is to be noted that, in the process table PT2 illustrated in FIG. 18, an area in which information is not stored or an area in which invalid information is stored is indicated by “-.” For example, since only a routing process is performed as the process for a packet whose identification number is “1,” no information is stored in the areas for the second process to the zth process.

Further, where the substance of the communication process executed for a packet whose identification number is “2” is two processes of routing and IPsec and besides the process of routing is executed first, information indicative of the virtual machine 50a(1) that executes a routing process is stored in the first process area A1. Meanwhile, in the second process area A2, for example, information indicative of the virtual machine 50a(2) that executes an IPsec process is stored. Further, in the first process area A1 in which the identification number is “2,” a process time period of routing by the virtual machine 50a(1) is stored. Further, in the second process area A2 in which the identification number is “2,” a process time period of IPsec by the virtual machine 50a(2) is stored. The process time period of routing and the process time period of IPsec are measured using a pseudo packet by the time measurement unit C4.

It is to be noted that, in the process table PT2 illustrated in FIG. 18, the communication process executed for a packet whose identification number is “4” is same as that for a packet whose identification number is “2,” namely, routing and IPsec. However, the order in which the communication processes are executed is opposite to that for the packet whose identification number is “2.”

FIG. 19 schematically illustrates an example of operation for packet transfer in the packet processing system SYS7 depicted in FIG. 17. In the example of FIG. 19, a case in which the retention unit 20b(2) that retains a packet whose identification number is “2” transfers a packet Pb1 to the server 200a(1) is illustrated. It is to be noted that also the retention units 20b(1) and 20(b)3 to 20b(L) operate similarly to the retention unit 20b(2). Further, in the example illustrated in FIG. 19, it is assumed that the maximum number of packets (credit number) processable by each virtual machine 50a is “3”; the number of packets (process number) being processed in the virtual machine 50a(1) is “2”; and the process number in the virtual machine 50a(2) is “0.” It is to be noted that the credit number may differ among the different virtual machines 50a.

FIG. 19A illustrates a state in which the retention unit 20b(2) of the transfer unit 60f(1) outputs the packet Pb1 to the server 200a(1) and then retains a packet Pb2 under the control of the control unit 40g depicted in FIG. 17. In this case, the counter unit 31b(1) of the transfer unit 60f(1) increases the process number by one to set the process number of the virtual machine 50a(1) to “3,” which is equal to the credit number, under the control of the adjustment unit 80. Meanwhile, the process number of the counter unit 31b(2) is kept “0.”

Further, in the process table PT2 illustrated in FIG. 18, the packet retained in the retention unit 20b(2) and having the chain ID “2” is processed by the virtual machines 50a(1) and 50a(2) in this order. Therefore, even where the process number of the counter unit 31b(2) is smaller than the credit number, the control unit 40g suppresses outputting of the packet Pb2 from the retention unit 20b(2). For example, the control unit 40g determines the logical AND (AND arithmetic operation) between the difference between the process number of the counter unit 31b(1) and the credit number and the difference between the process number of the counter unit 31b(2) and the credit number, and decides whether or not the packet Pb2 is to be outputted from the retention unit 20b(2). In FIG. 19A, for example, the absolute value of the difference between the process number of the counter unit 31b(1) and the credit number is “0” and the absolute value of the difference between the process number of the counter unit 31b(2) and the credit number is “3,” and the logical AND of the differences is “0.” In this case, the control unit 40g outputs an instruction to the retention units 20b(1) and 20b(2) and so forth to suppress outputting of a packet to the server 200a(1).

Further, the time measurement unit C4 of the transfer unit 60f(1) starts measurement of the elapsed time period with regard to the packet Pb1 in response to outputting of the packet Pb1 from the retention unit 20b(2). Since the chain ID of the received packet Pb1 is “2,” the server 200a(1) transfers the packet Pb1 to the virtual machine 50a(1) that executes a communication process of routing. Then, the virtual machine 50a(1) starts a communication process of routing for the packet Pb1.

Then, if the elapsed time period of the time measurement unit C4 becomes equal to or longer than the process time period (one second) of the virtual machine 50a(1) in the process table PT2 in FIG. 19B, the adjustment unit 80 decides that the process for the packet Pb1 by the virtual machine 50a(1) has ended. Then, the adjustment unit 80 refers to the virtual machine 50a of the second process area A2 whose identification number is “2” in the process table PT2 and decides that the packet Pb1 has been transferred to the virtual machine 50a(2) that executes a process of IPsec. In this case, the adjustment unit 80 decreases the count number of the counter unit 31b(1) by one to set the process number of the virtual machine 50a(1) to “2.” On the other hand, the adjustment unit 80 increases the count number of the counter unit 31b(2) by one to set the process number of the virtual machine 50a(2) to “1.” As a result, the process number of the counter unit 31b(1) becomes smaller than the credit number, and therefore, the logical AND becomes “1.” In this case, the control unit 40g decides that the packet Pb2 may be outputted from the retention unit 20b(2) to the server 200a(1). Alternatively, the control unit 40g decides that a packet may be outputted to the server 200a(1) from the retention unit 20b that retains a packet that has a chain ID of “1” or “4” or the like and for which a process by the virtual machine 50a(1) is to be executed.

Then, if the elapsed time period of the time measurement unit C4 becomes equal to or longer than the sum total (three seconds) of the process time periods of the virtual machines 50a(1) and 50a(2) in the process table PT2 in FIG. 19C, the adjustment unit 80 decides that the process for the packet Pb1 in the virtual machine 50a(2) has ended. In this case, the adjustment unit 80 decreases the count number of the counter unit 31b(2) by one to set the process number of the virtual machine 50a(2) to “0.” It is to be noted that the adjustment unit 80 may decrease the count number of the counter unit 31b(2) by one when it receives the packet Pb1 from the server 200a(1).

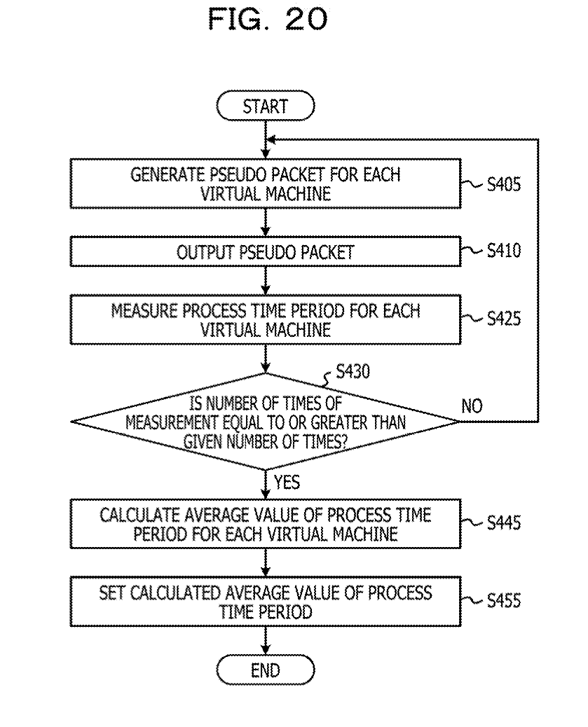

FIG. 20 illustrates an example of a setting process of a process time period in the packet processing system SYS7 depicted in FIG. 17. It is to be noted that, from among processes at steps depicted in FIG. 20, processes same as or similar to those at the steps described with reference to FIG. 14 are denoted by the same step numbers, and detailed description of such processes is omitted herein. The process illustrated in FIG. 20 is implemented by operation of the switch unit 11, N transfer units 60f and control unit 40g incorporated in the switching apparatus 100g.

It is to be noted that the process illustrated in FIG. 20 indicates a case where a pseudo packet is transferred between the transfer unit 60f(1) and the server 200a(1). Also when a pseudo packet is transferred between each of the transfer units 60f(2) to 60f(N) and a corresponding one of the servers 200a(2) to 200a(N), a process similar to that illustrated in FIG. 20 is executed.

Further, the process illustrated in FIG. 20 is executed before a packet process in the packet processing system SYS7. However, the process illustrated in FIG. 20 may be executed in parallel to the packet process in the packet processing system SYS7.

Alternatively, the process of FIG. 20 may be executed when the time difference between the total time period of the process time periods of the virtual machines 50a(1) and 50a(2) calculated using the process table PT2 illustrated in FIG. 18 and the process time period of the packet Pb1 measured by the time measurement unit C4 is equal to or greater than a given time difference. For example, when the time difference between the total time period of the processes calculated from the process table PT2 and the process time period measured by the time measurement unit C4 is equal to or greater than the given time difference, the packet processing system SYS7 updates the process time periods of the virtual machines 50a(1) and 50a(2) of the process table PT2. It is to be noted that, when the time difference between the total time period of the processes calculated from the process table PT2 and the process time period measured by the time measurement unit C4 is equal to or greater than the given time difference, the packet processing system SYS7 may update the process time periods of all virtual machines 50a of the process table PT2.

While, in the process illustrated in FIG. 14, a pseudo packet is generated, a process time period is measured and a process threshold value is calculated for each chain ID, in the process illustrated in FIG. 20, a pseudo packet is generated, a process time period is measured and an average value of the process time period is calculated for each virtual machine.

At step S405, the packet generation unit 27a generates a pseudo packet for being processed by each virtual machine 50a under the control of the adjustment unit 80. After the process at step S405 is executed, the processing of the switching apparatus 100g advances to step S410. Then, after the switching apparatus 100g executes the process at step S410, it executes the process at step S425.

At step S425, the time measurement unit C4 measures the process time period of a communication process by each virtual machine 50a of the server 200a(1) for the pseudo packet outputted at step S410. After the process at step S425 is executed, the processing of the switching apparatus 100g advances to step S430. Then, if the number of times of measurement of the process time period for each virtual machine 50a is equal to or greater than a given number of times in the process at step S430, the switching apparatus 100g executes a process at step S445. On the other hand, when the number of times of measurement of the process time period for each virtual machine 50a is lower than the given number of times in the process at step S430, the processing of the switching apparatus 100g advances to step S405. It is to be noted that the given number of times may be once.

At step S445, the adjustment unit 80 calculates an average value of the process time period of each virtual machine 50a using the process time periods of the virtual machines 50a measured at step S425 by the number of times equal to or greater than the given number of times. After the process at step S445 is executed, the processing of the switching apparatus 100g advances to step S455.

At step S455, the control unit 40g sets the average value of the process time period of each virtual machine 50a calculated at step S445 to the process table PT2. Then, the switching apparatus 100g ends the setting process of a process time period.

It is to be noted that, when the difference of the average value of the process time period calculated at step S445 for each virtual machine 50a from the process time period before the setting is greater than a given threshold value, the control unit 40g may perform such adjustment as to decrease the credit number set for the virtual machine 50a by one. Then, when the difference of the average value of the process time period calculated in the next measurement process of the process time period from the process time period before the setting is equal to or smaller than the given threshold value, the control unit 40g may perform such a process as to return the credit number set for the virtual machine 50a to its original value. For example, where the fluctuation of the process time period of each virtual machine 50a of the server 200a(1) is great, the packet processing system SYS7 adjusts the credit number of each virtual machine 50a. Consequently, the packet processing system SYS7 may avoid a situation that a packet is discarded in the server 200a(1) due to a failure or the like occurring with the switching apparatus 100g or the server 200a(1), and may suppress packet loss.

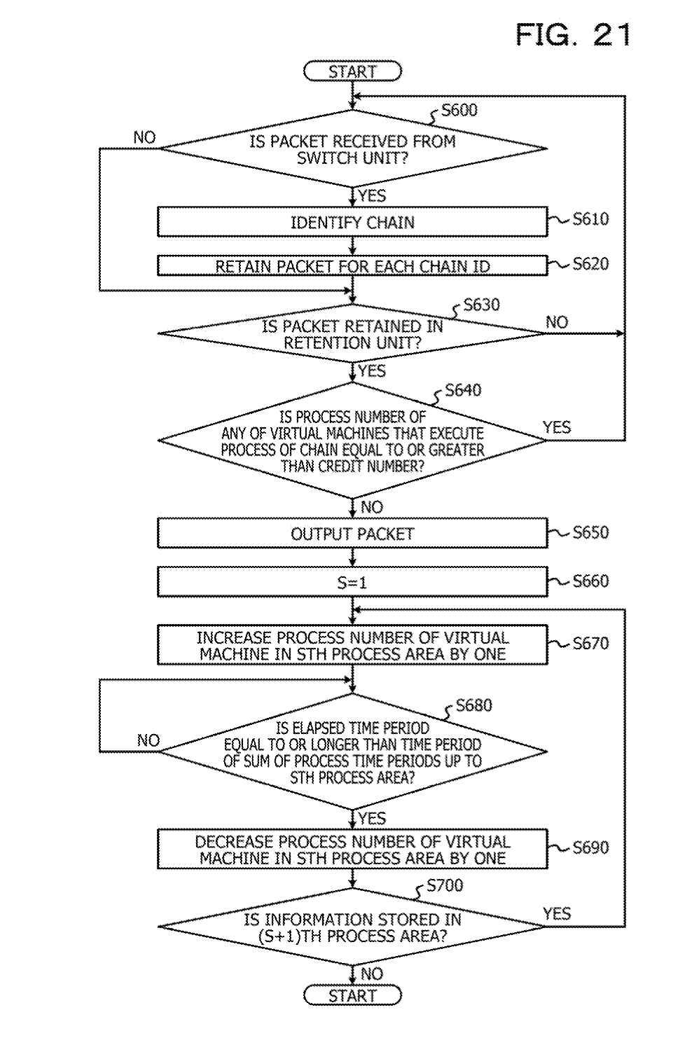

FIG. 21 illustrates an example of a switching process in the switching apparatus 100g depicted in FIG. 17. The process illustrated in FIG. 21 is implemented by operation of the switch unit 11, N transfer units 60f and control unit 40g incorporated in the switching apparatus 100g.

It is to be noted that the process illustrated in FIG. 21 indicates a case in which a packet is transferred between the transfer unit 60f(1) of the switching apparatus 100g and the server 200a(1). A process same as or similar to the process illustrated in FIG. 21 is executed also where a packet is transferred between each of the transfer units 60f(2) to 60f(N) and a corresponding one of the servers 200a(2) to 200a(N).

At step S600, the control unit 40g decides whether or not the transfer unit 60f(1) receives a packet from the switch unit 11. If a packet is received, the processing of the switching apparatus 100g advances to step S610. On the other hand, if a packet is not received, the processing of the switching apparatus 100g advances to step S630.

At step S610, the identification unit 15c identifies the chain of the received packet based on the VID of the VLAN tag header added to the packet received at step S600 and the process table PT2 illustrated in FIG. 18. Then, the identification unit 15c adds the identification number (chain ID) of the identification area IA of the process table PT2 illustrated in FIG. 18 as information indicative of the identified chain and the serial number to the packet. The identification unit 15c outputs the packet to which the chain ID and the serial number are added to the DEMUX 21. Then, the processing of the switching apparatus 100g advances to step S620.

At step S620, the DEMUX 21 distributes the packet outputted at step S610 to the retention unit 20b corresponding to the chain ID added to the packet, and each of the retention units 20b retains packets to which the same chain ID is added. Then, the processing of the switching apparatus 100g advances to step S630.

At step S630, the control unit 40g decides whether or not each retention unit 20b (for example, the chain ID) retains a packet. Then, if the retention unit 20b retains a packet, the processing of the switching apparatus 100g advances to step S640. On the other hand, if the retention unit 20b does not retain a packet, the processing of the switching apparatus 100g advances to step S600.

At step S640, the control unit 40g refers to the process table PT2 and decides whether or not the process number of any of the virtual machines 50a (counter units 31b) of the server 200a(1) which execute the substance of the communication process indicated by the chain ID is equal to or greater than the credit number. If the process number of any virtual machine 50a that executes the substance of the communication process indicated by the chain ID is equal to or greater than the credit number, the control unit 40g outputs an instruction to the retention unit 20b that is decided as retaining a packet of the chain ID to suppress outputting of a packet. In this case, the processing of the switching apparatus 100g returns to step S600. On the other hand, if the process number of all of the virtual machines 50a that execute the substance of the communication process indicated by the chain ID is smaller than the credit number, the processing of the switching apparatus 100g advances to step S650.

At step S650, the retention unit 20b that retains a packet of the chain ID decided at step S640 outputs the packet to the server 200a(1). In this case, the time measurement unit C4 starts measurement of the elapsed time period of the outputted packet. Then, the processing of the switching apparatus 100g advances to step S660.

At step S660, the adjustment unit 80 specifies the virtual machine 50a that is processing a packet based on the chain ID of the packet outputted at step S650, the elapsed time period measured by the time measurement unit C4 and the process table PT2. To this end, the adjustment unit 80 initializes a variable S to “1” and successively refers to the process table PT2 beginning with the information stored in the first process area A1. Then, the processing of the switching apparatus 100g advances to step S670.

At step S670, the adjustment unit 80 causes the counter unit 31b of the virtual machine 50a stored in the Sth process area to increase the process number by one. Then, the processing of the switching apparatus 100g advances to step S680.

At step S680, the adjustment unit 80 decides whether or not the elapsed time period measured by the time measurement unit C4 is equal to or longer than a period of time of the sum of the process time periods stored in the process areas from the first process area A1 to the Sth process area. If the elapsed time period measured by the time measurement unit C4 is equal to or longer than the period of time of the sum of the process time periods from the first process area A1 to the Sth process area, the processing of the switching apparatus 100g advances to step S690. On the other hand, if the elapsed time period is shorter than the period of time of the sum of the process time periods from the first process area A1 to the Sth process area, the switching apparatus 100g repeats the process at step S680 until after the elapsed time period becomes equal to or longer than the period of time of the sum of the process time periods.

At step S690, the adjustment unit 80 causes the counter unit 31b of the virtual machine 50a stored in the Sth process area to decrease the process number by one. Then, the processing of the switching apparatus 100g advances to step S700.

At step S700, the adjustment unit 80 decides based on the chain ID of the packet outputted at step S650 and the process table PT2 whether or not information indicative of a virtual machine 50a and a process time period is stored in the (S+1)th process area. If such information is stored in the (S+1)th process area, the adjustment unit 80 increases the value of the variable S by one. Then, the processing of the switching apparatus 100g advances to step S670. On the other hand, if such information is not stored in the (S+1)th process area, the packet processing system SYS7 ends the packet process.

Then, the switching apparatus 100g repetitively executes the process illustrated in FIG. 21. It is to be noted that the processes at steps S600 to S650 and the processes at steps S660 to S700 may be executed in parallel.

As described above, in the embodiment depicted in FIGS. 17 to 21, the adjustment unit 80 specifies, based on a chain ID of a packet outputted by the retention unit 20b, the elapsed time period measured by the time measurement unit C4 and the process table PT2, in which one of the virtual machines 50a each packet is being processed. The adjustment unit 80 adjusts the process number of packets being executed by each virtual machine 50a in each counter unit 31b based on the result of the specification. Then, the control unit 40g controls outputting of a packet from the retention unit 20b to the server 200a based on a comparison of the process number of each virtual machine 50a that executes the substance of a communication process indicated by the chain ID of each packet with the credit number. For example, the switching apparatus 100g controls outputting of a packet to the server 200a without receiving information indicating that the server 200a has no room in the processing capacity of packets from the server 200a. Consequently, even where the plurality of virtual machines 50a being executed in each server 200a do not have a function for requesting the switching apparatus 100g to stop transmission of a packet, the packet processing system SYS7 may control the transfer amount of packets by the switching apparatus 100g. As a result, the packet processing system SYS7 may suppress packet loss.

Further, since each counter unit 31b counts the process number in each virtual machine 50a, even when the substance of the communication process indicated by the chain ID is changed, the packet processing system SYS7 may cope with the change flexibly in comparison with the prior art.

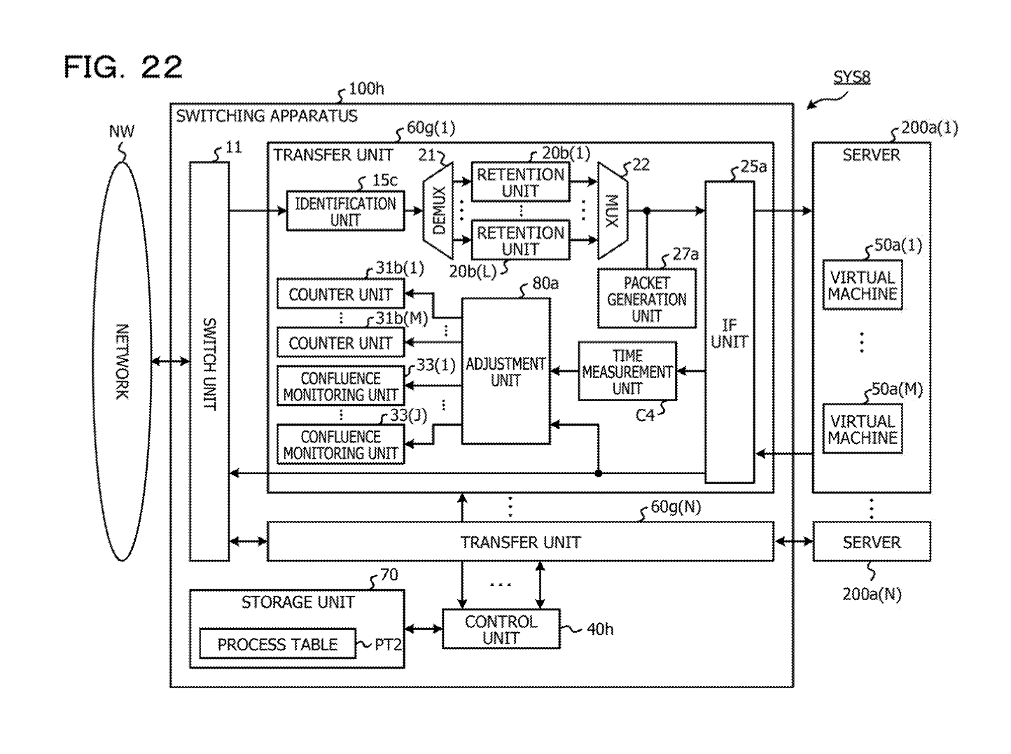

FIG. 22 depicts a still further different embodiment of a switching apparatus and a packet processing system. Elements having functions same as or similar to those of the elements described with reference to FIG. 17 are denoted by the same or like reference symbols, and detailed description of such elements is omitted herein.

A packet processing system SYS8 depicted in FIG. 22 includes a switching apparatus 100h and N servers 200a. The switching apparatus 100h is coupled to the N servers 200a and a network NW through wire or wireless coupling.

The switching apparatus 100h includes a switch unit 11, N transfer units 60g (60g(1) to 60g(N)), a control unit 40h and a storage unit 70.

The transfer unit 60h(1) includes an identification unit 15c, a DEMUX 21, L retention units 20b, a MUX 22, an IF unit 25a, a packet generation unit 27a, M counter units 31b, J confluence monitoring units 33 (33(1) to 33(J)), a time measurement unit C4 and an adjustment unit 80a. It is to be noted that also each of the transfer units 60g(2) to 60g(N) includes elements same as or similar to those of the transfer unit 60g(1) depicted in FIG. 22.

The adjustment unit 80a specifies, using an elapsed time period of each packet measured by the time measurement unit C4, a chain ID of each packet and the process table PT2, by which one of the virtual machines 50a each packet is being processed similarly to the adjustment unit 80 depicted in FIG. 17. The adjustment unit 80a adjusts the process number of each virtual machine 50a indicated by a corresponding one of the counter units 31b based on the result of the specification. Further, the adjustment unit 80a controls the confluence monitoring units 33 based on the result of the specification.

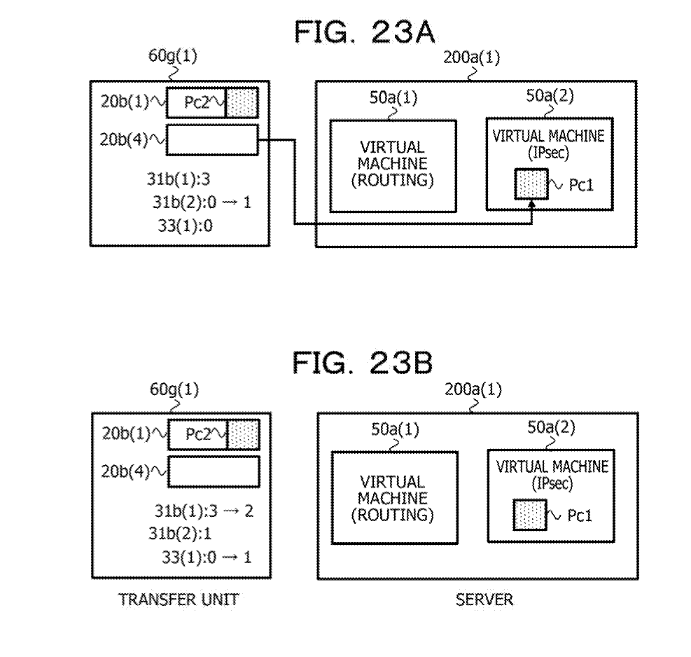

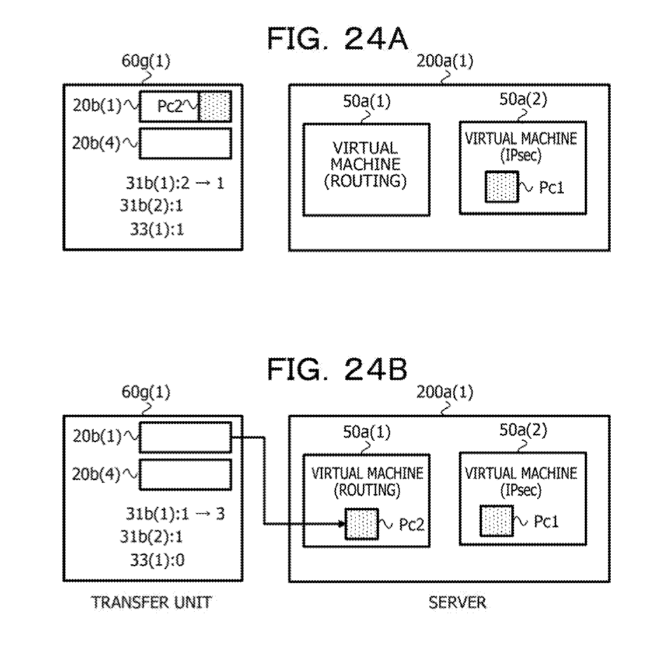

Each confluence monitoring unit 33 is an up/down counter or the like. For example, the confluence monitoring unit 33(1) monitors a packet transferred from the virtual machine 50a(2) to the virtual machine 50a(1) based on the result of the specification by the adjustment unit 80a. For example, the confluence monitoring unit 33(1) counts the process number of packets whose process is started by the virtual machine 50a(2) within a period from a point of time prior by the process time period (for example, one second) of the virtual machine 50a(1) to the present point of time to another point of time prior by the process time period (for example, two seconds) of the virtual machine 50a(2). Further, each of the confluence monitoring units 33(2) to 33(J) monitors a packet transferred from the virtual machine 50a of the transfer source to the virtual machine 50a of the transfer destination, whose process time period is shorter than that of the virtual machine 50a of the transfer source, similarly to the confluence monitoring unit 33(1) based on the process table PT2. For example, each of the confluence monitoring units 33(2) to 33(J) counts the process number of packets whose process is started by the virtual machine 50a of the transfer source within a range from a point of time prior by the process time period of the virtual machine 50a of the transfer destination to the present point of time to another point of time prior by the process time period of the virtual machine 50a of the transfer source. Operation of the confluence monitoring unit 33 is described with reference to FIGS. 23 and 24.

The control unit 40h is implemented by a processor included in the switching apparatus 100h or the like and controls operation of the switching apparatus 100h by executing a control program stored in the storage unit 70. Then, based on the monitoring of the confluence monitoring unit 33, the control unit 40h controls each retention unit 20b such that, in the virtual machine 50a(1) and so forth, collision between a packet outputted from the retention unit 20b(1) or the like and another packet from the virtual machine 50a(2) or the like may be avoided. Operation of the control unit 40h is described with reference to FIGS. 23 and 24.

It is to be noted that the control unit 40h executes control same as or similar to that for the transfer unit 60g(1) also for the transfer units 60g(2) to 60g(N).

It is to be noted that the packet processing system SYS8 is not limited to the example depicted in FIG. 22. For example, the control unit 40h may be provided in each transfer unit 60g and control operation of the transfer unit 60g. Further, the storage unit 70 may store the process table PT2 for each transfer unit 60g.

Incidentally, the control unit 40g of the packet processing system SYS7 depicted in FIG. 17 suppresses outputting of a packet of a chain ID including a process of the virtual machine 50a(1) when the process number of the virtual machine 50a(1) is equal to the credit number as in such a situation as illustrated in FIG. 19A.

However, in the process table PT2 illustrated in FIG. 18, the process time period of the virtual machine 50a(2) is two seconds longer than one second of the process time period of the virtual machine 50a(1). Further, in the situation illustrated in FIG. 19A, the process number of the virtual machine 50a(2) is smaller than the credit number. From this, it may be estimated that, if, for example, a packet whose chain ID is “4” is outputted from the retention unit 20b(4) in the situation of FIG. 19A, two seconds later, when the first process of the virtual machine 50a(2) ends, the process number of the virtual machine 50a(1) is smaller than the credit number. For example, even in a case in which a packet whose chain ID is “4” is outputted in the situation of FIG. 19A, the packet whose chain ID is “4” is processed regularly by a process of IPsec of the virtual machine 50a(2) and a process of routing of the virtual machine 50a(1) in this order. Thus, the efficiency of the packet process in the entire system may be improved.

However, for example, if the retention unit 20b(4) outputs three packets to the virtual machine 50a(2) in the situation illustrated in FIG. 19A, two seconds later as the process time period of the virtual machine 50a(2), the virtual machine 50a(1) is occupied by three packets. In this case, it is difficult for the retention unit 20b that retains a packet that is processed first by the virtual machine 50a(1) such as a packet whose chain ID is “1” or “2” to output a packet. Alternatively, if the retention unit 20b that retains a packet whose chain ID is “1” or the like outputs a packet, the packet whose chain ID is “1” or the like joins together at the virtual machine 50a(1) and collides with the three packets transferred from the virtual machine 50a(2). Then, the server 200a(1) sometimes discards some packets such that the process number of the virtual machine 50a(1) may become smaller than the credit number. As a result, the processing efficiency of packets of the entire system degrades.

FIGS. 23 and 24 schematically illustrate an example of operation for packet transfer in the packet processing system SYS8 depicted in FIG. 22. In the example illustrated in FIGS. 23 and 24, it is assumed that the maximum number of packets (credit number) processable by each virtual machine 50a is “3.” It is to be noted that the credit number may differ among the different virtual machines 50a. Further, in the example illustrated in FIGS. 23 and 24, the retention unit 20b(1) has a packet Pct whose chain ID is “1” and that is processed first by the virtual machine 50a(1). Further, in the example illustrated in FIGS. 23 and 24, the retention unit 20b(4) retains a packet whose chain ID is “4” and that is processed by the virtual machines 50a(2) and 50a(1) in this order.

It is to be noted that, immediately before the situation illustrated in FIG. 23A, it is assumed that the counter unit 31b(1) indicates the number of packets (process number) being processed by the virtual machine 50a(1) as “3” and the counter unit 31b(2) indicates the process number being processed by the virtual machine 50a(2) as “0.” Further, it is assumed that the process number indicated by the confluence monitoring unit 33(1) is “0.”

Referring to FIG. 23A, since the process number “0” of the counter unit 31b(2) is smaller than the credit number, the control unit 40h outputs an instruction to the retention unit 20b(4) to output a packet Pc1 to the server 200a(1). Then, the server 200a(1) transfers the packet Pc1 to the virtual machine 50a(2) based on the chain ID. As a result, the counter unit 31b(2) increases the process number of the virtual machine 50a(2) by one to “1.” On the other hand, in FIG. 23A, the process number “3” of the counter unit 31b(1) is equal to the credit number. Therefore, the control unit 40h depicted in FIG. 22 outputs an instruction to the retention unit 20b(1) to suppress outputting of the packet Pc2 to the server 200a(1).

Then, FIG. 23B illustrates a situation at a point of time at which the elapsed time period measured by the time measurement unit C4 is shorter than one second (process time period of the virtual machine 50a(1)) from outputting of the packet Pc1. In FIG. 23B, processing for one packet ends, for example, in the virtual machine 50a(1). Consequently, the counter unit 31b(1) decreases the process number of the virtual machine 50a(1) by one to “2.” Further, if the virtual machine 50a(2) has started, from the result of the specification by the adjustment unit 80a, processing of one packet within a range from a point of time one second prior to the situation of FIG. 23B to another point of time two seconds prior to the situation, the confluence monitoring unit 33(1) increases the process number by one to “1.”

On the other hand, the control unit 40h decides based on the process number of the counter unit 31b(1) and the process number indicated by the confluence monitoring unit 33(1) whether or not the packet Pc2 is to be outputted to the retention unit 20b(1). In the example illustrated in FIG. 23B, the process number indicated by the confluence monitoring unit 33(1) is “1.” For example, it is indicated that, when the packet Pc2 is outputted, the number of packets that are transferred from the virtual machine 50a(2) and which join together with the packet Pc2 at the virtual machine 50a(1) before next one second (process time period of the virtual machine 50a(1)) elapses is one. Then, when the packets join together, if processing of at least one of the two packets being processed does not end in the virtual machine 50a(1), the control unit 40h decides that one packet from the virtual machine 50a(2) and the packet Pc2 collide with each other. In this case, the control unit 40h outputs an instruction to the retention unit 20b(1) to suppress outputting of the packet Pc2 to the server 200a(1).

It is to be noted that, if a packet is transferred, for example, to the virtual machine 50a(2) from a different virtual machine 50a whose process time period is longer than that of the virtual machine 50a(2), in FIG. 23A, the control unit 40h executes a decision process similar to that described with reference to FIG. 23B.

Then, FIG. 24A illustrates a situation in which the elapsed time period measured by the time measurement unit C4 is equal to or longer than one second (process time period of the virtual machine 50a(1)) and is shorter than two seconds (process time period of the virtual machine 50a(2)) after the packet Pc1 is outputted. For example, the virtual machine 50a(1) has ended the process for the two packets having been processed in FIG. 23B and is processing one packet transferred thereto from the virtual machine 50a(2). In this case, the counter unit 31b(1) counts the process number of the virtual machine 50a(1) as “1.” Further, if the virtual machine 50a(2) has started processing of one packet within a range from a point of time one second prior to the situation of FIG. 24A to another point of time two seconds prior to the situation, the confluence monitoring unit 33(1) sets the process number to “1.”

In this case, the sum total of the process number of the counter unit 31b(1) and the process number indicated by the confluence monitoring unit 33(1) is smaller than the credit number of the virtual machine 50a(1). For example, even when the packet Pc2 is outputted to the retention unit 20b(1), the control unit 40h decides that one packet transferred from the virtual machine 50a(2) before one second elapses subsequently and the packet Pc2 do not collide with each other in the virtual machine 50a(1).

Referring to FIG. 24B, the control unit 40h outputs an instruction to the retention unit 20b(1) to output the packet Pc2 to the server 200a(1). Then, if one packet from the virtual machine 50a(2) and the packet Pc2 are received by the virtual machine 50a(1), the counter unit 31b(1) increases the process number of the virtual machine 50a(1) by two to “3.” On the other hand, if the virtual machine 50a(2) has started processing of no packet within a range from a point of time one second prior to the situation of FIG. 24B to another point of time two seconds prior to the situation, the confluence monitoring unit 33(1) decreases the process number by one to “0.”

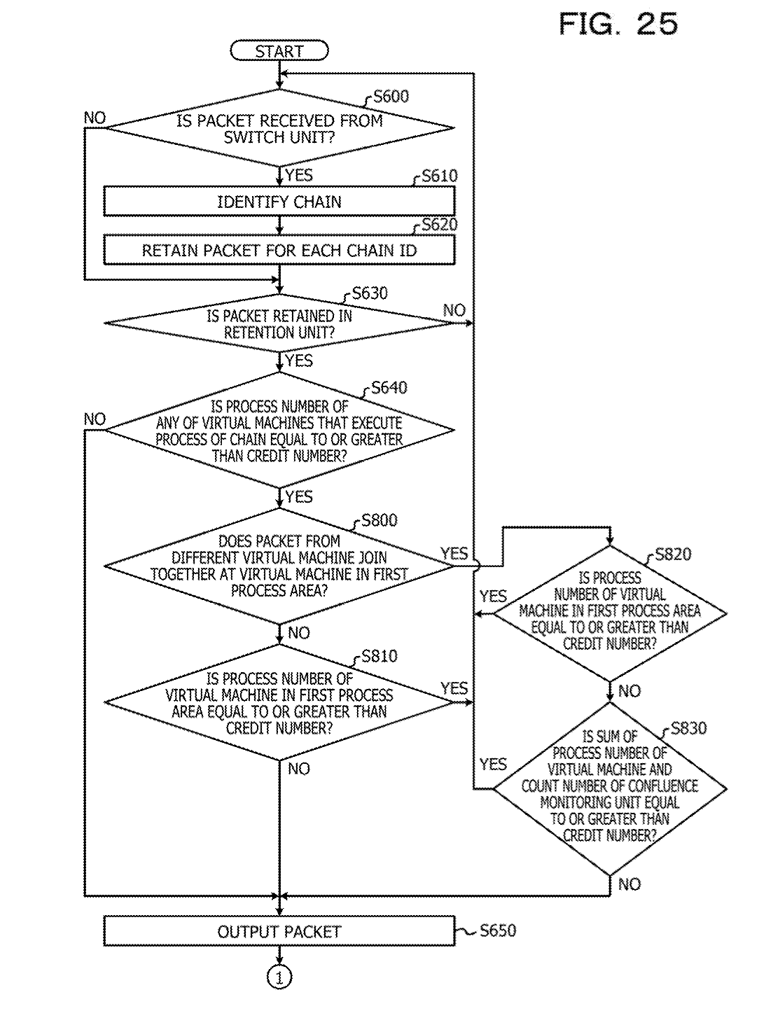

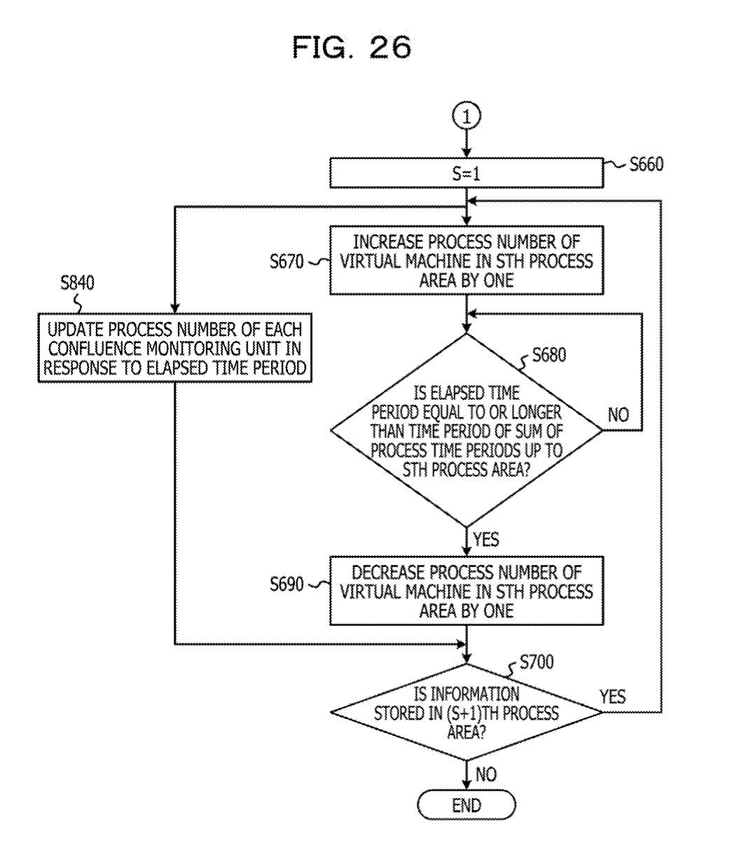

FIGS. 25 and 26 illustrate an example of a switching process in the switching apparatus 100h depicted in FIG. 22. It is to be noted that, from among processes at steps depicted in FIGS. 25 and 26, processes same as or similar to those at the steps described with reference to FIG. 21 are denoted by the same step numbers, and detailed description of such processes is omitted herein. The process illustrated in FIGS. 25 and 26 are implemented by operation of the switch unit 11, N transfer units 60g and control unit 40h incorporated in the switching apparatus 100h.

It is to be noted that the process illustrated in FIGS. 25 and 26 indicates a case in which a packet is transferred between the transfer unit 60g(1) and the server 200a(1). Further, a process similar to the process illustrated in FIGS. 25 and 26 is executed also where a packet is transferred between each of the transfer units 60g(2) to 60g(N) and a corresponding one of the servers 200a(2) to 200a(N).

The switching apparatus 100h executes processes at steps S600 to S640. It is to be noted that, if the process number of any of the virtual machines 50a that execute the substance of the communication process indicated by the chain ID is equal to or greater than the credit number at step S640, the processing of the switching apparatus 100h advances to step S800. On the other hand, if the process number of all of the virtual machines 50a that execute the substance of the communication process indicated by the chain ID is smaller than the credit number, the processing of the switching apparatus 100h advances to step S650.

At step S800, the control unit 40h refers to the process table PT2 and decides whether or not, at the virtual machine 50a stored in the first process area A1 of the chain ID (identification number) identified at step S610, a packet from a different virtual machine 50a joins together. The virtual machine 50a in the first process area A1 is hereinafter referred to also as first virtual machine 50a. If a packet from a different virtual machine 50a joins together at the first virtual machine 50a, the processing of the switching apparatus 100h advances to step S820. The case in which a packet from the different virtual machine 50a joins together at the first virtual machine 50a is a case in which information indicative of the first virtual machine 50a is stored in an area such as the second process area A2 of the process table PT2.

On the other hand, if a packet from a different virtual machine 50a does not join together at the first virtual machine 50a, the processing of the switching apparatus 100h advances to step S810.

At step S810, the control unit 40h decides whether or not the process number of the first virtual machine 50a is equal to or greater than the credit number. If the process number of the first virtual machine 50a is equal to or greater than the credit number, the control unit 40h outputs an instruction to the retention unit 20b, which retains the packet of the chain ID identified at step S610, to suppress outputting of a packet to the server 200a(1). In this case, the processing of the switching apparatus 100h advances to step S600. On the other hand, if the process number of the first virtual machine 50a is smaller than the credit number, the processing of the switching apparatus 100h advances to step S650.

At step S820, the control unit 40h decides whether or not the process number of the first virtual machine 50a at which a packet from a different virtual machine 50a joins together is equal to or greater than the credit number. If the process number of the first virtual machine 50a is equal to or greater than the credit number, the control unit 40h outputs an instruction to the retention unit 20b, which retains a packet of the chain ID identified at step S610, to suppress outputting of a packet to the server 200a(1). In this case, the processing of the switching apparatus 100h advances to step S600. On the other hand, if the process number of the first virtual machine 50a is smaller than the credit number, the processing of the switching apparatus 100h advances to step S830.

At step S830, the control unit 40h totals all of the process numbers of the confluence monitoring units 33 of the virtual machines 50a that have a process time period longer than that of the first virtual machine 50a and transfer a packet to the first virtual machine 50a and the process number of the first virtual machine 50a. Then, the control unit 40h decides whether or not the total value is equal to or greater than the credit number of the first virtual machine 50a. If the total value is equal to or greater than the credit number of the first virtual machine 50a, the control unit 40h outputs an instruction to the retention unit 20b, which retains a packet of the chain ID identified at step S610, to suppress outputting of a packet to the server 200a(1). In this case, the processing of the switching apparatus 100h advances to step S600. On the other hand, if the total value is smaller than the credit number of the first virtual machine 50a, the processing of the switching apparatus 100h advances to step S650.

The switching apparatus 100h executes processes at step S650 and at steps S660 to S700 and step S840 illustrated in FIG. 26. It is to be noted that the switching apparatus 100h executes the processes at steps S670 to S690 and the process at step S840 in parallel after it executes the process at step S660.

At step S840, each confluence monitoring unit 33 updates the process number of packets whose process is started by the virtual machine 50a of the transfer source within a period from a point of time prior by the process time period of the virtual machine 50a of the transfer destination to the present point of time to another point of time prior by the process time period of the virtual machine 50a of the transfer source in response to the elapsed time period measured by the time measurement unit C4.

Then, the switching apparatus 100h repetitively executes the process illustrated in FIGS. 25 and 26.

It is to be noted that, although the process at step S840 is executed in parallel to the processes at steps S670 to S690, the process at step S840 may be executed in parallel to the processes at steps S600 to S700.

As described above, in the embodiment depicted in FIGS. 22 to 26, the adjustment unit 80a specifies, based on a chain ID of a packet outputted from the retention unit 20b, an elapsed time period of the time measurement unit C4 and the process table PT2, in which virtual machine 50a each packet is being executed. The adjustment unit 80a adjusts, based on the result of the specification, the process number, counted by each counter unit 31b, of packets being executed by each virtual machine 50a. Then, the control unit 40h controls, based on comparison between the process number in each virtual machine 50a and the credit number, outputting of a packet from each retention unit 20b to the server 200a. For example, the switching apparatus 100h controls outputting of a packet to the server 200a without receiving information indicating that the server 200a has no room in the processing capacity of packets from the server 200a. Consequently, even where the plurality of virtual machines 50a being executed in each server 200a do not have a function for requesting the switching apparatus 100h to stop transmission of a packet, the packet processing system SYS8 may control the transfer amount of packets by the switching apparatus 100h. As a result, the packet processing system SYS8 may suppress packet loss.

Further, the confluence monitoring unit 33 monitors a packet transferred from a virtual machine 50a of the transfer source to another virtual machine 50a of the transfer destination, which has a shorter packet process time period than the virtual machine 50a of the transfer source, based on the result of the specification of the adjustment unit 80a. Then, the confluence monitoring unit 33 counts the process number of packets whose process is started by the virtual machine 50a of the transfer source within a range from a point of time prior by the process time period of the virtual machine 50a of the transfer destination to the present point of time to another point of time prior by the process time period of the virtual machine 50a of the transfer source. The control unit 40h decides, based on the process number of each virtual machine 50a, the process table PT2 and the process number of the confluence monitoring unit 33, whether or not a collision between packets occurs in the packet process. Then, if the control unit 40h decides that a collision of packets does not occur, it outputs an instruction to the retention unit 20b to output a packet to the server 200a. Consequently, the packet processing system SYS8 may effectively utilize each virtual machine 50a of the server 200a(1) and may achieve improvement in efficiency in packet process in comparison with the packet processing system SYS7 depicted in FIG. 17.

Further, since each counter unit 31b counts the process number in a corresponding one of the virtual machines 50a, even if the substance of the communication process indicated by a chain ID is changed, the packet processing system SYS8 may cope with the change flexibly in comparison with the prior art.

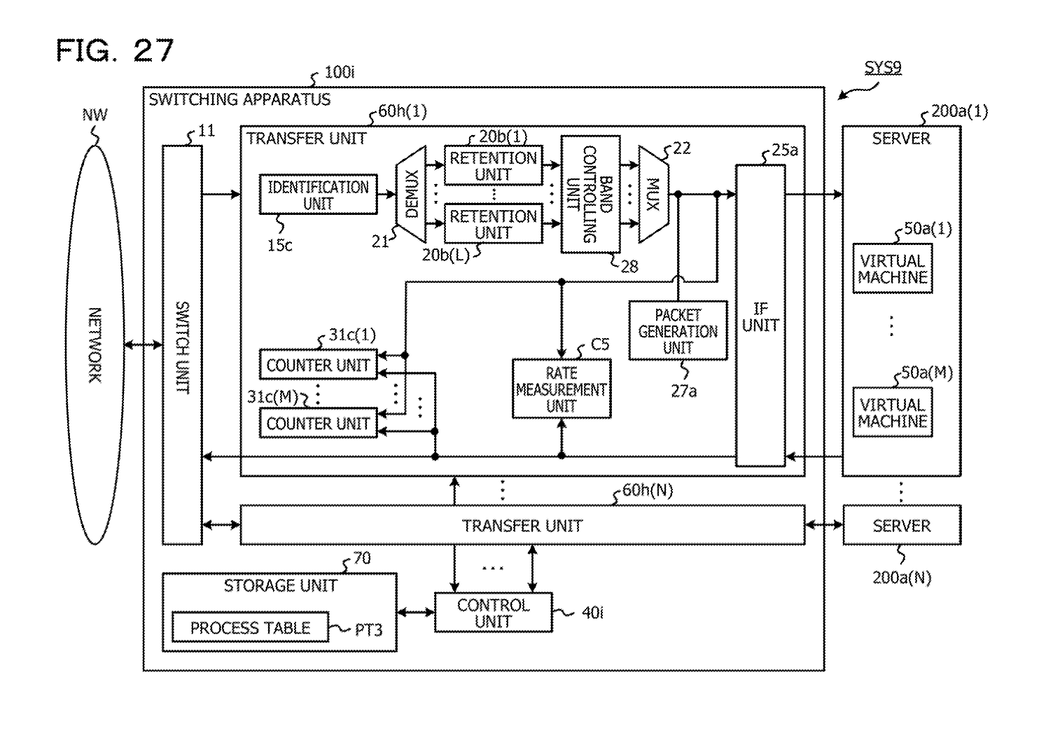

FIG. 27 depicts a yet further different embodiment of a switching apparatus and a packet processing system. Elements having functions same as or similar to those of the elements described with reference to FIG. 17 are denoted by the same or like reference symbols, and detailed description of such elements is omitted herein.

A packet processing system SYS9 depicted in FIG. 27 includes a switching apparatus 100i and N servers 200a. The switching apparatus 100i is coupled to the N servers 200a and a network NW through wire or wireless coupling.

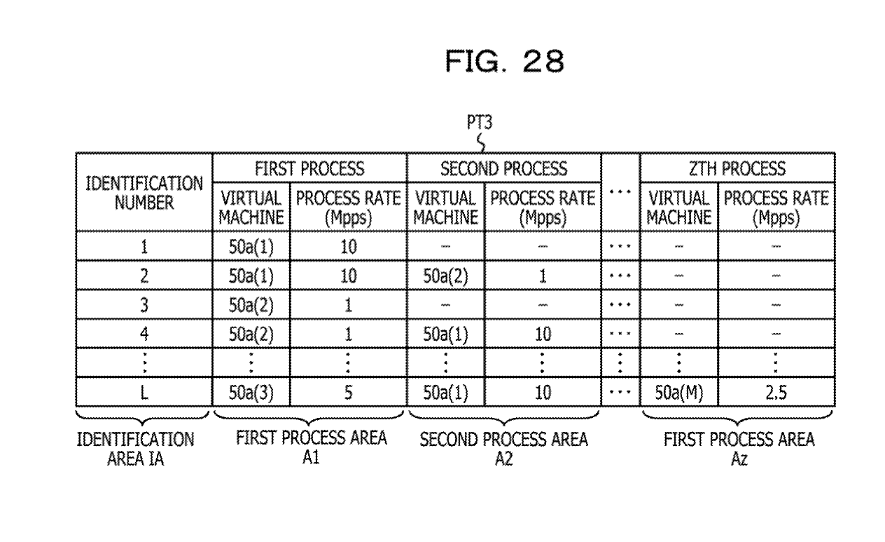

The switching apparatus 100i includes a switch unit 11, N transfer units 60h (60h(1) to 60h(N)), a control unit 40i and a storage unit 70. The storage unit 70 includes a storage area for storing a process table PT3 in place of the process table PT2 illustrated in FIG. 17. The process table PT3 is described with reference to FIG. 28.

The transfer unit 60h(1) includes an identification unit 15c, a DEMUX 21, L retention units 20b (20b(1) to 20b(L)), a MUX 22, a band controlling unit 28, an IF unit 25a, a packet generation unit 27a, M counter units 31c (31c(1) to 31c(M)) and a rate measurement unit C5. It is to be noted that also each of the transfer units 60h(2) to 60h(N) includes elements same as or similar to those of the transfer unit 60h(1) depicted in FIG. 27.

The band controlling unit 28 controls the band of a packet outputted from the retention unit 20b based on a process such as shaping for allocating a band in response to a priority degree such as quality of service (QoS). For example, the band controlling unit 28 controls the band based on a process rate of each virtual machine 50a stored in the process table PT3 and the substance of a communication process indicated by the chain ID of the packet outputted from the retention unit 20b. It is to be noted that operation of the band controlling unit 28 is described with reference to FIG. 28.

The counter units 31c(1) to 31c(M) are up/down counters or the like and count the number of packets (process number) processed in the virtual machines 50a(1) to 50a(M), respectively. For example, every time each retention unit 20b outputs a packet to the server 200a(1), each counter unit 31c increases, based on information indicative of a virtual machine 50a included in the substance of a communication process indicated by the chain ID of the outputted packet, the process number of each virtual machine 50a by one. Further, every time a packet after processing is received from the server 200a(1), each counter unit 31c decreases, based on information that indicates a virtual machine 50a included in the substance of a communication process indicated by the chain ID of the packet after processing, the process number of each virtual machine 50a by one.

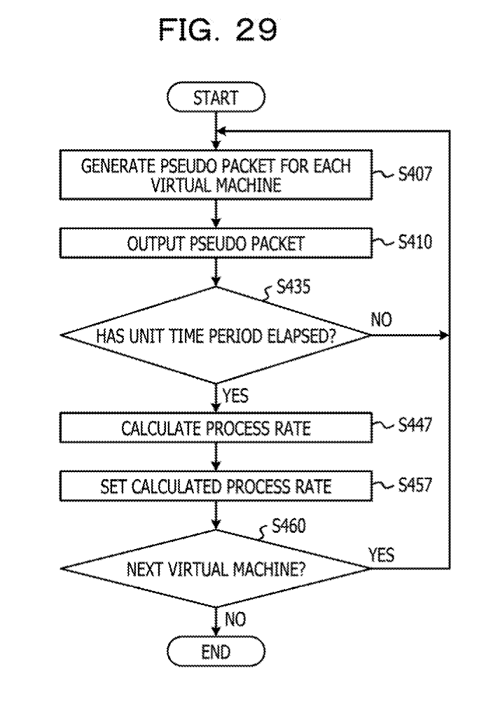

The rate measurement unit C5 measures an output rate and a process rate of packets for each virtual machine 50a. The rate measurement unit C5 measures, as the output rate, the number of packets per unit time period (for example, one second) outputted from the retention unit 20b to the server 200a(1) using information indicative of time from a clock circuit included in the switching apparatus 100i or the like. Further, the rate measurement unit C5 calculates, as the process rate, the number of packets per unit time period processed by each virtual machine 50a based on the substance of a communication process indicated by the chain ID of a packet after processing received from the server 200a(1). Then, the rate measurement unit C5 stores the calculated process rate for each virtual machine 50a into the process table PT3. Operation of the rate measurement unit C5 is described with reference to FIG. 29.

It is to be noted that the packet outputted to the server 200a(1) may be a packet received from the network NW or may be a pseudo packet generated by the packet generation unit 27a. Further, where a pseudo packet is used, the rate measurement unit C5 may cause, within each unit time period, the packet generation unit 27a to generate a pseudo packet to be processed by any virtual machine 50a of the virtual machines 50a and may measure the process rate of each virtual machine 50a.

The control unit 40i is implemented, for example, by execution of a control program stored in the storage unit 70 by a processor or the like included in the switching apparatus 100i and controls operation of the switching apparatus 100i. Then, the control unit 40i controls outputting of a packet to the server 200a(1) from each retention unit 20b based on the process number of each virtual machine 50a counted by each counter unit 31c and the output rate and the process rate of each virtual machine 50a measured by the rate measurement unit C5.

It is to be noted that, also for the transfer units 60h(2) to 60h(N), the control unit 40i executes control same as or similar to that for the transfer unit 60h(1).

It is to be noted that the packet processing system SYS9 is not limited to the example depicted in FIG. 27. For example, the control unit 40i may be provided in each transfer unit 60h such that it controls operation of the transfer unit 60h. Further, the storage unit 70 may store the process table PT3 for each transfer unit 60h.

FIG. 28 illustrates an example of the process table PT3 illustrated in FIG. 27. The process table PT3 includes a plurality of entries similarly to the process table PT2 illustrated in FIG. 18. Each entry includes an identification area IA for retaining an identification number, and a first process area A1 to a zth process area Az for retaining the substance of the first to zth processes, respectively.

In the area for an identification number (identification area IA), a value of a VID for identifying a VLAN to which a packet belongs is stored as an identification number similarly as in the process table PT2 illustrated in FIG. 18. The value of the VID is included in the VLAN tag header added to a packet received from the network NW. It is to be noted that, in the identification area IA, an IP address, a MAC address or the like indicative of a transmission destination or a transmission source of a received packet may be stored in place of the VID.

Each of the first process area A1 to the zth process area Az retains information indicative of a virtual machine 50a that executes a communication process and information indicative of a process rate. The information retained in each of the first process area A1 to the zth process area Az is retained in an order in accordance with the substance of a communication process executed for each packet having a VID (identification number). For example, where the communication process executed for a packet whose identification number is “1” is a process of routing by the virtual machine 50a(1), information indicative of the virtual machine 50a(1) is stored in the first process area A1 similarly as in the process table PT2 illustrated in FIG. 18. Further, in the first process area A1, a process rate (for example, ten mega packet per second (pps)) of the virtual machine 50a(1) measured by the rate measurement unit C5 is stored. It is to be noted that, in the process table PT3 illustrated in FIG. 28, an area in which no information is stored or an area in which invalid information is stored is indicated by “-” similarly as in the process table PT2 illustrated in FIG. 18. For example, since the process for a packet whose identification number is “1” is only a process of routing, information is not stored in the areas for the second process to the zth process.

FIG. 29 illustrates an example of a setting process of a process rate in the packet processing system SYS9 depicted in FIG. 27. It is to be noted that, from among processes at steps depicted in FIG. 29, processes same as or similar to those at the steps described with reference to FIG. 20 are denoted by the same step numbers, and detailed description of such processes is omitted herein. The process illustrated in FIG. 29 is implemented by operation of the switch unit 11, N transfer units 60h and control unit 40i incorporated in the switching apparatus 100i.

It is to be noted that the process illustrated in FIG. 29 indicates a case in which a pseudo packet is transferred between the transfer unit 60h(1) and the server 200a(1). Further, a process similar to the process illustrated in FIG. 29 is executed also where a pseudo packet is transferred between each of the transfer units 60h(2) to 60h(N) and a corresponding one of the servers 200a(2) to 200a(N).

Further, the process illustrated in FIG. 29 is executed before a packet process in the packet processing system SYS9. However, the process illustrated in FIG. 29 may be executed in parallel to a packet process in the packet processing system SYS9.

At step S407, the packet generation unit 27a generates a pseudo packet to be processed by one virtual machine 50a of the virtual machines 50a under the control of the control unit 40i. After the process at step S407 is executed, the processing of the switching apparatus 100i advances to step S410. Then, after the switching apparatus 100i executes a process at step S410, it executes a process at step S435.

At step S435, the rate measurement unit C5 decides, using information indicative of time outputted from the clock circuit of the switching apparatus 100i or the like, whether or not a unit time period such as one second has elapsed after a first pseudo packet is outputted at step S410. If the unit time period has elapsed, the processing of the switching apparatus 100i advances to step S447. On the other hand, if the unit time period has not elapsed, the processing of the switching apparatus 100i advances to step S407.

At step S447, the rate measurement unit C5 calculates a process rate of the virtual machine 50a based on the number of pseudo packets after processing received from the server 200a(1) before the unit time period elapses at step S435. Then, the processing of the switching apparatus 100i advances to step S457.

At step S457, the control unit 40i sets the process rate of the virtual machine 50a calculated at step S447 to the process table PT3. Then, the processing of the switching apparatus 100i advances to step S460.

At step S460, the rate measurement unit C5 decides whether or not the process rate of a next virtual machine 50a is to be measured. If the process rate of a next virtual machine 50a is to be measured, the processing of the switching apparatus 100i advances to step S407. On the other hand, if the process rate of all of the virtual machines 50a has been measured, the switching apparatus 100i ends the setting process.

It is to be noted that, in each of the virtual machines 50a, when the difference of the process rate calculated at step S447 from the process rate before setting is greater than a given threshold value, the control unit 40i may perform such adjustment as to decrease the credit number set for the virtual machine 50a by one. Then, when the difference of the process rate calculated in the next measurement process of the process time period from the process rate before setting is equal to or smaller than a given threshold value, the control unit 40i may perform such a process as to return the credit number set for the virtual machine 50a to its original value. For example, when the fluctuation of the process rate of each virtual machine 50a of the server 200a(1) is great, the packet processing system SYS9 adjusts the credit number of each virtual machine 50a. Consequently, the packet processing system SYS9 may avoid a situation that a packet is discarded in the server 200a(1) because of a failure or the like that occurs in the switching apparatus 100i or the server 200a(1), and may suppress packet loss.

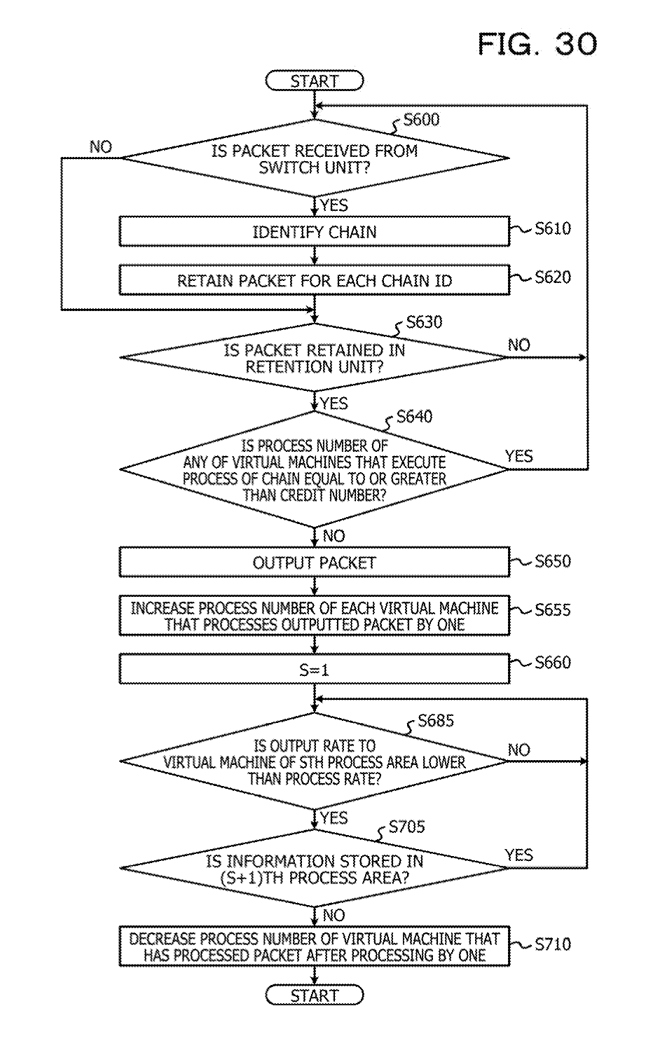

FIG. 30 illustrates an example of a switching process in the switching apparatus 100i depicted in FIG. 27. It is to be noted that, from among processes at steps depicted in FIG. 30, processes same as or similar to those at the steps described with reference to FIG. 21 are denoted by the same step numbers, and detailed description of such processes is omitted herein. The process illustrated in FIG. 30 is implemented by operation of the switch unit 11, N transfer units 60h and control unit 40i incorporated in the switching apparatus 100i.

It is to be noted that the process illustrated in FIG. 30 indicates a case in which a packet is transferred between the transfer unit 60h(1) of the switching apparatus 100i and the server 200a(1). Further, a process same as or similar to the process illustrated in FIG. 30 is executed also where a packet is transferred between each of the transfer units 60h(2) to 60h(N) and a corresponding one of the servers 200a(2) to 200a(N).

In FIG. 30, a step S655 is inserted between the steps S650 and S660 illustrated in FIG. 21, and steps S685, S705 and S710 are executed in place of the steps S670, S680, S690 and S700 illustrated in FIG. 21.

At step S655, the counter unit 31c increases the process number of the virtual machine 50a, which processes the packet outputted at step S650, by one based on the chain ID of the outputted packet and the process table PT3. Then, the processing of the switching apparatus 100i advances to step S660, at which the variable S is initialized to “1,” whereafter the processing of the switching apparatus 100i advances to step S685.

At step S685, the control unit 40i decides whether or not the output rate measured by the rate measurement unit C5 is lower than the process rate of the virtual machine 50a stored in the Sth process area. If the output rate of the rate measurement unit C5 is lower than the process rate of the virtual machine 50a of the Sth process area, the control unit 40i decides that the number of packets outputted to the server 200a(1) is within the range of the processing capacity the virtual machine 50a of the Sth process area has. Then, the processing of the switching apparatus 100i advances to step S705. On the other hand, if the output rate of the rate measurement unit C5 is equal to or higher than the process rate of the virtual machine 50a of the Sth process area, the control unit 40i decides that the number of packets outputted to the server 200a(1) exceeds the range of the processing capacity the virtual machine 50a of the Sth process area has. In this case, the control unit 40i suppresses, for example, outputting of a packet from the retention unit 20b. Then, the switching apparatus 100i repeats the process at step S685 until after the output rate becomes lower than the process rate of the virtual machine 50a of the Sth process area. Then, the processing of the switching apparatus 100i advances to step S705.

At step S705, the control unit 40i decides based on the chain ID of the packet outputted at step S650 and the process table PT3 whether or not information indicative of a virtual machine 50a and a process rate is stored in the (S+1)th process area. If information is stored in the (S+1)th process area, the control unit 40i increases the value of the variable S by one. Then, the processing of the switching apparatus 100i advances to step S685. On the other hand, if information is not stored in the (S+1)th process area, the processing of the switching apparatus 100i advances to step S710.

At step S710, if a packet after processing is received from the server 200a(1), the counter unit 31c decreases the process number of the virtual machine 50a, by which the packet after processing has been processed, by one based on the chain ID of the packet after processing and the process table PT3.

Then, the switching apparatus 100i repetitively executes the process illustrated in FIG. 30. It is to be noted that the processes at steps S600 to S650 and the processes at steps S655 to S710 may be executed in parallel.

As described above, in the embodiment depicted in FIGS. 27 to 30, each counter unit 31c counts the process number of packets being executed by each virtual machine 50a based on the chain ID of a packet outputted from the retention unit 20b to the server 200a and the process table PT3. Then, the control unit 40i controls outputting of a packet from the retention unit 20b to the server 200a based on a comparison of the process number of the virtual machine 50a, which executes the substance of a communication process indicated by the chain ID of the packet, with the credit number.

Further, the rate measurement unit C5 measures the output rate of packets transferred from the transfer unit 60h to the server 200a and the process rate in each virtual machine 50a. Then, the control unit 40i compares the output rate and the process rate of each virtual machine 50a to monitor the load of the process to each virtual machine 50a and controls outputting of a packet from the retention unit 20b to the server 200a.

Consequently, the switching apparatus 100i controls outputting of a packet to the server 200a without receiving information indicating that the server 200a has no room in the processing capacity of packets from the server 200a. Then, also where the plurality of virtual machines 50a being executed in each server 200a do not have a function for requesting the switching apparatus 100i to stop transmission of a packet, the packet processing system SYS9 may control the transfer amount of packets by the switching apparatus 100i. As a result, the packet processing system SYS9 may suppress packet loss.

From the foregoing detailed description, characteristics and advantages of the embodiments will become clear. It is intended by this that the claims embrace such characteristics and advantages of the embodiments as described above without departing from the spirit and scope of the claims. Further, those having an ordinary skill in the technical field could readily conceive any improvement and alteration. Accordingly, it is not intended to limit the scope of embodiments having inventiveness to those described above, and also it is possible for the claims to rely upon suitable improvements and equivalents included in the range disclosed in the embodiments.

What is claimed is:

1. A control apparatus comprising:
a memory; and
a processor coupled to the memory and the processor configured to:
retain first packets in the memory;
output the retained first packets to a processing apparatus including a packet processor;
receive second packets processed by the packet processor from the processing apparatus; and
control outputting of the retained first packets based on the outputted first packets and the received second packets.

2. The control apparatus according to claim 1, wherein the processor is configured:
for each first packet of the first packets, identify processing executed for the first packet by the packet processor based on content of the first packet;
for each identified processing, retain the first packets to the memory;
for each identified processing, determine amount of processing executed for the first packets by the packet processor; and
for each identified processing, control outputting of the retained first packets based on the determined amount of processing.

3. The control apparatus according to claim 1, wherein the processor is configured:
for each first packet of the first packets, identify processing among executed for the first packet by the packet processor based on content of the first packet;
for each identified processing, retain the first packets to the memory;
for each identified processing, measure a first time period of processing executed for the first packets by the packet processor;
measure a second time period that elapses from lastly outputting a packet among the retained first packet;
determine a third time period based on the first time period, the third time period being a time period during which one of identified processing is completed;
output, when a load of a next packet to the lastly outputted packet is lighter than a load of the lastly outputted packet and the second time period is longer than the third time period, the next packet to the processing apparatus.

4. The control apparatus according to claim 1, wherein the processor is configured:
for each identified processing, output a pseudo packet for making the processing apparatus process the identified processing; and
the first time period is measured based on the pseudo packet.

5. The control apparatus according to claim 1, wherein the processor is configured:
determine a number of third packets, being processed by the packet processor, based on a number of the retained first packets and a number of the received second packets; and
control outputting of the retained first packets so that the number of the third packets does not exceed a maximum number of packets that the packet processor is capable of processing.

6. The control apparatus according to claim 1, wherein the processor is configured:
determine a data size of third packets, being processed by the packet processor, based on a data size of the retained first packets and a data size of the received second packets; and
control outputting of the retained first packets so that the data size of the third packets does not exceed a maximum data size of packets that the packet processor is capable of processing.

7. A control method comprising:
retaining first packets in a control apparatus;
outputting the retained first packets from the control apparatus to a processing apparatus including a packet processor;
receiving, by the control apparatus, second packets processed by the packet processor from the processing apparatus; and
controlling, by the control apparatus, outputting of the retained first packets based on the outputted first packets and the received second packets.

8. A control system comprising:
a processing apparatus including a packet processor; and
a control apparatus including:
a memory; and
a processor coupled to the memory and the processor configured to:
retain first packets in the memory;
output the retained first packets to the processing apparatus;
receive second packets processed by the packet processor from the processing apparatus; and
control outputting of the retained first packets based on the outputted first packets and the received second packets.
